(19) United States
(12) Patent Application Publication
(10) Pub. No.: US 2014/0314003 A1
(43) Pub. Date: Oct. 23, 2014

(54) ACCESS POINT DISCOVERY CHANNEL

(71) Applicant: QUALCOMM Incorporated, San Diego, CA (US)

(72) Inventors: Yan ZHOU, San Diego, CA (US); Santosh Paul ABRAHAM, San Diego, CA (US); Gwendolyn Denise BARRIAC, Encinitas, CA (US); Simone MERLIN, Solana Beach, CA (US); Rahul TANDRA, San Diego, CA (US); Hemanth SAMPATH, San Diego, CA (US)

(73) Assignee: QUALCOMM Incorporated, San Diego, CA (US)

(21) Appl. No.: 14/255,899

(22) Filed: Apr. 17, 2014

Related U.S. Application Data
(60) Provisional application No. 61/813,781, filed on Apr. 19, 2013.
(60) Provisional application No. 61/820,888, filed on May 8, 2013.

(51) Int. Cl. H04W 48/16

(52) U.S. Cl. CPC H04W 48/16
USPC 370/329; 370/338

(57) ABSTRACT

Access points communicate via a discovery channel. For example, access points may transmit at a higher transmit power and at a lower rate on the discovery channel than on operating channels. In this way, the radio frequency range of the discovery channel is longer than the range of any of the operating channels. Consequently, a particular access point can communicate with and thereby account for other access points that the particular access point might not hear via an operating channel.

### CLAIM OF PRIORITY

This application claims the benefit of and priority to commonly owned U.S. Provisional Patent Application No. 61/813,781, filed Apr. 19, 2013, assigned Attorney Docket No. 131324P1, and U.S. Provisional Patent Application No. 61/820,888, filed May 8, 2013, assigned Attorney Docket No. 131324P2, the disclosure of each of which is hereby incorporated by reference herein.

### BACKGROUND

1. Field

This application relates generally to wireless communication and more specifically, but not exclusively, to an access point discovery channel.

2. Introduction

Communication networks enable users to exchange messages among several interacting spatially-separated devices. Communication networks may be classified according to geographic scope, which could be, for example, a wide area, a metropolitan area, a local area, or a personal area. Such networks may be designated respectively as a wide area network (WAN), a metropolitan area network (MAN), a local area network (LAN), or a personal area network (PAN). Communication networks also differ according to the switching technique and/or routing technique employed to interconnect the various network apparatuses and devices. For example, a communication network may use circuit switching, packet switching, or some combination of the two. Communication networks can differ according to the type of physical media employed for transmission. For example, a communication network may support wired communication, wireless communication, or both types of communication. Communication networks can also use different sets of communication protocols. Examples of such communication protocols include the Internet protocol (IP) suite, synchronous optical networking (SONET) protocols, and Ethernet protocols.

In general, wireless networks employ intangible physical media in an unguided propagation mode using electromagnetic waves in radio, microwave, infrared, optical, or other frequency bands. Consequently, wireless networks are better adapted to facilitate user mobility and rapid field deployment as compared to fixed, wired networks. For example, wireless networks readily support network elements that are mobile and have dynamic connectivity needs. The use of wireless networks also may be preferred for scenarios where it is desirable to provide a network architecture having an ad hoc topology, rather than a fixed topology.

A wireless network may be deployed over a defined geographical area to provide various types of services (e.g., voice, data, multimedia services, etc.) to users within that geographical area. In a typical implementation, one or more access points are deployed to provide wireless connectivity for access terminals (e.g., STAs) that are operating within the geographical area served by the wireless network.

In some wireless networks, an access point collects information about neighboring access points. For example, to reduce interference induced at neighboring access points, each access point can select its operating parameters (e.g., operating channel number and transmit power) based on information about each neighboring access point. This information may include, for example, the path loss from a neighboring access point and the operating channel used by the neighboring access point. An access point may acquire this information in various ways.

In some cases, an access point discovers its neighboring access points by decoding the beacons transmitted on the neighboring access points' operating channels. In practice, however, an access point might not discover neighboring access points that transmit at a relatively low power. Consequently, the access point may not be able to protect such a neighboring access point from interference.

In some cases, an access point requests associated access terminals to report observed neighboring access points. However, an access terminal also might not discover neighboring access points that transmit at a relatively low power. Hence, use of this approach also may fail to protect neighboring access points. Moreover, this approach requires the use of access terminal resources to search for neighboring access points.

### SUMMARY

A summary of several example aspects of the disclosure follows. This summary is provided for the convenience of the reader to provide a basic understanding of such aspects and does not wholly define the breadth of the disclosure. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later. For convenience, the term some aspects may be used herein to refer to a single aspect or multiple aspects of the disclosure.

The disclosure relates in some aspects to a discovery channel. Here, in addition to transmitting and receiving traffic on its own operating channel(s), each access point in a network can communicate with one or more neighboring access points via a discovery channel. In some aspects, the discovery channel can carry information about the access point's operating channel(s) as well as the discovery channel.

In some aspects, an access point may transmit at a higher transmit power and at a lower rate on the discovery channel, such that the radio frequency (RF) range of the discovery channel is longer than the range of any corresponding operating channel. Consequently, a particular access point can communicate with and thereby account for other access points that use operating channels that the particular access point cannot hear.

In some cases, the discovery channel operates on a channel frequency that is different from any operating channel frequency. For example, the discovery channel can advantageously be selected in an unlicensed band to mitigate interference with any operating channels.

Access points may use the discovery channel for various purposes. For example, an access point can obtain information of discovered access points (e.g., path loss and operating channel number) to optimize operating parameters. As another example, an access point can negotiate with discovered access points for joint actions (e.g., joint coverage adaptation for load balancing). As yet another example, an access point can exchange the list of neighboring access points observed by served access terminals for power calibration purposes.

A configuring manager (e.g., at a network entity or access point) may dynamically define the discovery channel. For example, the parameters of the discovery channel may be selected to avoid interference on the discovery channel from nearby interferers or to mitigate interference that the discovery channel induces on operating channels. Geographic discovery zones (e.g., non-overlapping zones) may be established so that operating parameters of access points within a given discovery zone are optimized with respect to one another.

Various aspects of the disclosure provide an apparatus configured for communication. The apparatus comprises: a processing system configured to determine information indicative of at least one first parameter associated with a first channel supported by the apparatus or at least one second parameter associated with a second channel supported by the apparatus; and a transmitter configured to transmit the information via the second channel.

Other aspects of the disclosure provide a method of communication. The method comprises: determining information indicative of at least one first parameter associated with a first channel supported by an apparatus or at least one second parameter associated with a second channel supported by the apparatus; and transmitting the information via the second channel.

Other aspects of the disclosure provide another apparatus configured for communication. The other apparatus comprises: means for determining information indicative of at least one first parameter associated with a first channel supported by an apparatus or at least one second parameter associated with a second channel supported by the apparatus; and means for transmitting the information via the second channel.

Other aspects of the disclosure provide a computer-program product comprising a computer-readable medium. The computer-readable medium comprises code executable to: determine information indicative of at least one first parameter associated with a first channel supported by an apparatus or at least one second parameter associated with a second channel supported by the apparatus; and transmit the information via the second channel.

Other aspects of the disclosure provide an access point. The access point comprises: an antenna; a processing system configured to determine information indicative of at least one first parameter associated with a first channel supported by the apparatus or at least one second parameter associated with a second channel supported by the apparatus; and a transmitter configured to transmit the information via the antenna on the second channel.

Various additional aspects of the disclosure provide an apparatus configured for communication. The apparatus comprises: a receiver configured to receive at least one parameter of a discovery channel for communication among a plurality of apparatuses, wherein the discovery channel is associated with a communication range that is longer than any communication range associated with any operating channel of any of the plurality of apparatuses; and a processing system configured to communicate with at least one of the plurality of apparatuses via the discovery channel, wherein the communication employs the received at least one parameter.

Other aspects of the disclosure provide a method of communication. The method comprises: receiving at least one parameter of a discovery channel for communication among a plurality of apparatuses, wherein the discovery channel is associated with a communication range that is longer than any communication range associated with any operating channel of any of the plurality of apparatuses; and communicating with at least one of the plurality of apparatuses via the discovery channel, wherein the communication employs the received at least one parameter.

Other aspects of the disclosure provide another apparatus configured for communication. The other apparatus comprises: means for receiving at least one parameter of a discovery channel for communication among a plurality of apparatuses, wherein the discovery channel is associated with a communication range that is longer than any communication range associated with any operating channel of any of the plurality of apparatuses; and means for communicating with at least one of the plurality of apparatuses via the discovery channel, wherein the communication employs the received at least one parameter.

Other aspects of the disclosure provide a computer-program product comprising a computer-readable medium. The computer-readable medium comprises code executable to: receive at least one parameter of a discovery channel for communication among a plurality of apparatuses, wherein the discovery channel is associated with a communication range that is longer than any communication range associated with any operating channel of any of the plurality of apparatuses; and communicate with at least one of the plurality of apparatuses via the discovery channel, wherein the communication employs the received at least one parameter.

Other aspects of the disclosure provide an access point. The access point comprises: an antenna; a receiver configured to receive, via the antenna, at least one parameter of a discovery channel for communication among a plurality of apparatuses, wherein the discovery channel is associated with a communication range that is longer than any communication range associated with any operating channel of any of the plurality of apparatuses; and a processing system configured to communicate with at least one of the plurality of apparatuses via the discovery channel, wherein the communication employs the received at least one parameter.

Various aspects of the disclosure provide an apparatus configured for communication. The apparatus comprises: a receiver configured to receive information regarding operating conditions at a plurality of apparatuses; a processing system configured to define at least one parameter of a discovery channel for communication among the plurality of apparatuses, wherein the definition of the at least one parameter is based on the received information, and wherein the discovery channel is associated with a communication range that is longer than any communication range associated with any operating channel of any of the plurality of apparatuses; and a transmitter configured to send the at least one parameter to the plurality of apparatuses.

Other aspects of the disclosure provide a method of communication. The method comprises: receiving information regarding operating conditions at a plurality of apparatuses; defining at least one parameter of a discovery channel for communication among the plurality of apparatuses, wherein the definition of the at least one parameter is based on the received information, and wherein the discovery channel is associated with a communication range that is longer than any communication range associated with any operating channel of any of the plurality of apparatuses; and sending the at least one parameter to the plurality of apparatuses.

Other aspects of the disclosure provide another apparatus configured for communication. The other apparatus comprises: means for receiving information regarding operating conditions at a plurality of apparatuses; means for defining at least one parameter of a discovery channel for communication among the plurality of apparatuses, wherein the definition of the at least one parameter is based on the received information, and wherein the discovery channel is associated with a communication range that is longer than any communication range associated with any operating channel of any of the plurality of apparatuses; and means for sending the at least one parameter to the plurality of apparatuses.

Other aspects of the disclosure provide a computer-program product comprising a computer-readable medium. The computer-readable medium comprises code executable to: receive information regarding operating conditions at a plurality of apparatuses; define at least one parameter of a discovery channel for communication among the plurality of apparatuses, wherein the definition of the at least one parameter is based on the received information, and wherein the discovery channel is associated with a communication range that is longer than any communication range associated with any operating channel of any of the plurality of apparatuses; and send the at least one parameter to the plurality of apparatuses.

Other aspects of the disclosure provide an access point. The access point comprises: an antenna; a receiver configured to receive information regarding operating conditions at a plurality of apparatuses; a processing system configured to define at least one parameter of a discovery channel for communication among the plurality of apparatuses, wherein the definition of the at least one parameter is based on the received information, and wherein the discovery channel is associated with a communication range that is longer than any communication range associated with any operating channel of any of the plurality of apparatuses; and a transmitter configured to send, via the antenna, the at least one parameter to the plurality of apparatuses.

Other aspects of the disclosure provide a network device. The network device comprises: a network interface configured to configured to receive information regarding operating conditions at a plurality of apparatuses; and a processing system configured to define at least one parameter of a discovery channel for communication among the plurality of apparatuses, wherein the definition of the at least one parameter is based on the received information, and wherein the discovery channel is associated with a communication range that is longer than any communication range associated with any operating channel of any of the plurality of apparatuses; and wherein the network interface is further configured to send the at least one parameter to the plurality of apparatuses.

### BRIEF DESCRIPTION OF THE DRAWINGS

These and other sample aspects of the disclosure will be described in the detailed description and the claims that follow, and in the accompanying drawings, wherein:

FIG. 1 illustrates an example of coverage areas of a discovery channel and operating channels in accordance with some aspects of the disclosure;

FIG. 2 is a functional block diagram illustrating discovery channel-related communication in accordance with some aspects of the disclosure;

FIG. 3 is a functional block diagram illustrating configuration of discovery channel parameters in accordance with some aspects of the disclosure;

FIG. 4 illustrates an example of a format for a discovery channel in accordance with some aspects of the disclosure;

FIG. 5 illustrates an example of discovery zones in accordance with some aspects of the disclosure;

FIG. 6 is a flowchart illustrating configuration of discovery channel parameters in accordance with some aspects of the disclosure;

FIG. 7 is a flowchart illustrating adaptation of operating parameters based on information received via a discovery channel in accordance with some aspects of the disclosure;

FIG. 8 is a flowchart illustrating several sample aspects of operations relating to communication via a discovery channel in accordance with some aspects of the disclosure;

FIG. 9 is a flowchart illustrating several sample aspects of operations relating to communication via a discovery channel in accordance with some aspects of the disclosure;

FIG. 10 is a flowchart illustrating several additional aspects of operations relating to communication via a discovery channel in accordance with some aspects of the disclosure;

FIG. 11 is a flowchart illustrating several sample aspects of operations relating to defining a discovery channel in accordance with some aspects of the disclosure;

FIG. 12 is a flowchart illustrating several additional aspects of operations relating to defining a discovery channel in accordance with some aspects of the disclosure;

FIG. 13 illustrates an example of a network environment in which one or more aspects of the disclosure may find application;

FIG. 14 is a functional block diagram illustrating an exemplary apparatus that may be employed within a wireless communication system in accordance with some aspects of the disclosure;

FIG. 15 is a functional block diagram illustrating exemplary components that may be utilized in the apparatus of FIG. 14 to transmit wireless communication;

FIG. 16 is a functional block diagram illustrating exemplary components that may be utilized in the apparatus of FIG. 14 to receive wireless communication;

FIG. 17 is a functional block diagram illustrating several sample aspects of components that may be employed in communication nodes in accordance with some aspects of the disclosure; and

FIGS. 18-20 are functional block diagrams illustrating several sample aspects of apparatuses configured with functionality relating to a discovery channel in accordance with some aspects of the disclosure.

In accordance with common practice, the features illustrated in the drawings are simplified for clarity and are generally not drawn to scale. That is, the dimensions and spacing of these features are expanded or reduced for clarity in most cases. In addition, for purposes of illustration, the drawings generally do not depict all of the components that are typically employed in a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, any aspect disclosed herein may be embodied by one or more elements of a claim. As an example of the above, in some aspects, a method of wireless communication may comprise receiving at least one parameter of a discovery channel for communication among a plurality of apparatuses, wherein the discovery channel is associated with a communication range that is longer than any communication range associated with any operating channel of any of the plurality of apparatuses, and communicating with at least one of the plurality of apparatuses via the discovery channel, wherein the communication employs the received at least one parameter. In addition, in some aspects, the communication via the discovery channel comprises communicating at least one indication of transmit power used on an operating channel.

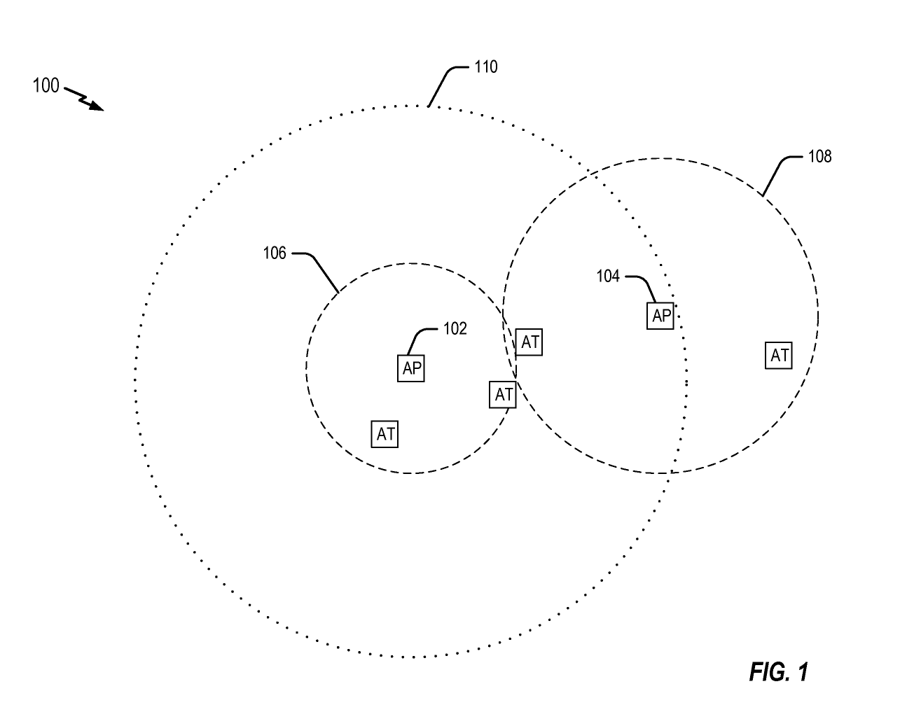

FIG. 1 illustrates an example of a wireless communication network 100 including a first access point (AP) 102 and a second access point 104. The first access point 102 uses an operating channel to communicate with any access terminals (ATs) that are within the coverage area 106 of the operating channel. Similarly, the second access point 104 uses an operating channel to communicate with any access terminals (ATs) that are within the coverage area 108 of the operating channel.

The access point 102 also supports a discovery channel that may be used to communicate information about the operating channel and the discovery channel. For example, the discovery channel may include information indicative of the transmit power used by the access point 102 on the operating channel, the transmit power used by the access point 102 on the discovery channel, identifiers of the access point 102 (e.g., service set identifier (SSID) and basic service set identifier (BSSID)), and a primary channel of the access point 102.

In some implementations, the discovery channel may have a larger coverage area 110 than the coverage area 106 of the operating channel of the access point 102. As indicated in the example of FIG. 1, the range of the coverage area 110 is large enough to enable the access point 104 to discover the access point 102.

Accordingly, the access point 104 may discover the existence of the access point 102 and certain parameters of the access point 102, and thereby take the access point 102 into account when configuring the operating channels or other aspects of the access point 104. As one example, the access point 104 may set the transmit power for its operating channel such that the operating channel does not interfere with communication operations at the access point 102. For example, the access point 104 may limit the range of its operating channel transmission so that these transmissions do not interfere with reception at an access terminal being served by the access point 102.

To reduce the complexity of FIG. 1, only a limited number of access points, access terminals, operating channels, and discovery channels are represented in the figure. In practice, a wireless communication network may employ more access points, access terminals, operating channels, discovery channels, and other components.

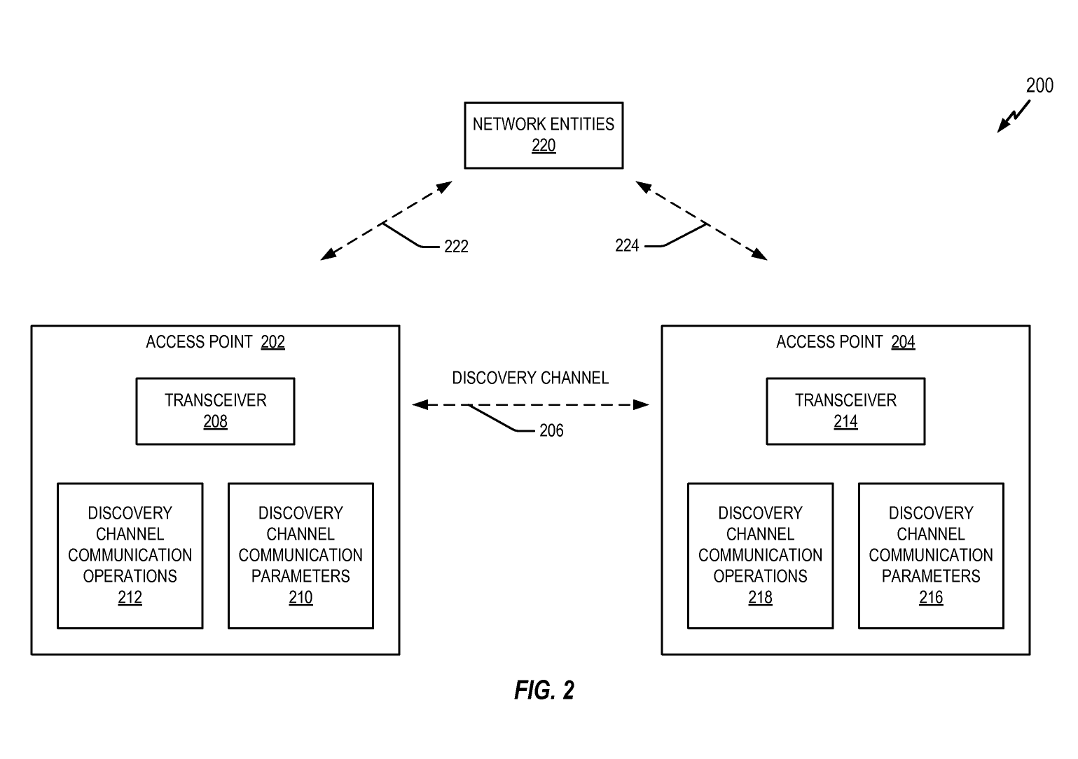

Referring now to FIGS. 2-4, various aspects of a communication channel that may be used for communication between access points in a wireless network will be described. For purposes of illustration, certain aspects of the communication channel (e.g., a control channel) may be described in the context of a discovery channel that is known by (e.g., common to) multiple access points. Hence, the discovery channel may be referred to as a common discovery channel. Various aspects of a discovery channel may be described herein in the context of an IEEE 802.11-based system. It should be appreciated, however, that the teachings herein may be implemented using other types of components, using other types of communication technology, and using other nomenclature.

FIG. 2 illustrates a communication network 200 where a first access point 202 communicates with a second access point 204 via a discovery channel 206. As illustrated in FIG. 2, each of the first and second access points 202 and 204 include several components to facilitate communication over the discovery channel 206.

The access point 202 includes a transceiver 208 that transmits and receives RF signals over the discovery channel 206 based on discovery channel communication parameters 210. As discussed in more detail below, discovery channel communication operations 212 at the access point 202 may configure the discovery channel 206 (e.g., according to the communication parameters 210) and use the transceiver 208 to send and receive information over the discovery channel 206. For example, the communication operations 212 may involve transmitting discovery beacons, receiving information from the access point 204 or some other access point, and sending information to the access point 204 or some other access point.

The access point 204 includes a transceiver 214 that transmits and receives RF signals over the discovery channel 206 based on discovery channel communication parameters 216 (e.g., corresponding to the communication parameters 210). As discussed in more detail below, discovery channel communication operations 218 at the access point 204 may configure the discovery channel 206 (e.g., according to the communication parameters 216) and use the transceiver 214 to send and receive information over the discovery channel 206. For example, the communication operations 218 may involve receiving discovery beacons, receiving information from the access point 202, and sending information to the access point 202.

In general, each access point in a communication network may provide a discovery channel. For example, the first access point 202 may transmit discovery beacons over the discovery channel 206 and communicate with other access points via the discovery channel 206. Similarly, the second access point 204 may transmit discovery beacons over another discovery channel (not shown in FIG. 2) and communicate with other access points via that other discovery channel.

In addition, each access point may receive discovery beacons and otherwise communicate with its neighbor access points over the respective discovery channel for each of those neighbor access points. For example, the second access point 204 may receive discovery beacons from the first access point 202 via the discovery channel 206 and communicate with the first access point 202 via the discovery channel 206. Similarly, the first access point 202 may receive discovery beacons from the second access point 204 via another discovery channel (not shown in FIG. 2) and communicate with the second access point 204 via that other discovery channel.

To reduce the complexity of FIG. 2, only two access points and one discovery channel are represented in the figure. In practice, a communication network may employ more access points, discovery channels, and other components.

The configuration of a wireless control channel (e.g., discovery channel) for inter-node (e.g., access point) communication may be determined via negotiation among nodes and/or with an external server. This configuration includes the node (access point) transmission schedule in terms of time and frequency. The negotiation between nodes can take place over a wired network and/or a wireless network.

FIG. 2 illustrates an example, where the first and second access points 202 and 204 could communicate discovery channel parameters. Such communication could be used, for example, in the event the first and second access points 202 and 204 are able to communicate with one another via a backhaul (e.g., via network entities 220 and associated communication channels 222 and 224) or some other mechanism, but do not know whether they may interfere with one another. In such a case, the first access point 202 could inform the second access point 204 of the communication parameters that the first access point selected for the discovery channel 206. Similar communication could be used to enable the second access point 204 to inform the first access point 202 of the communication parameters to be used by the second access point 204 for its discovery channel.

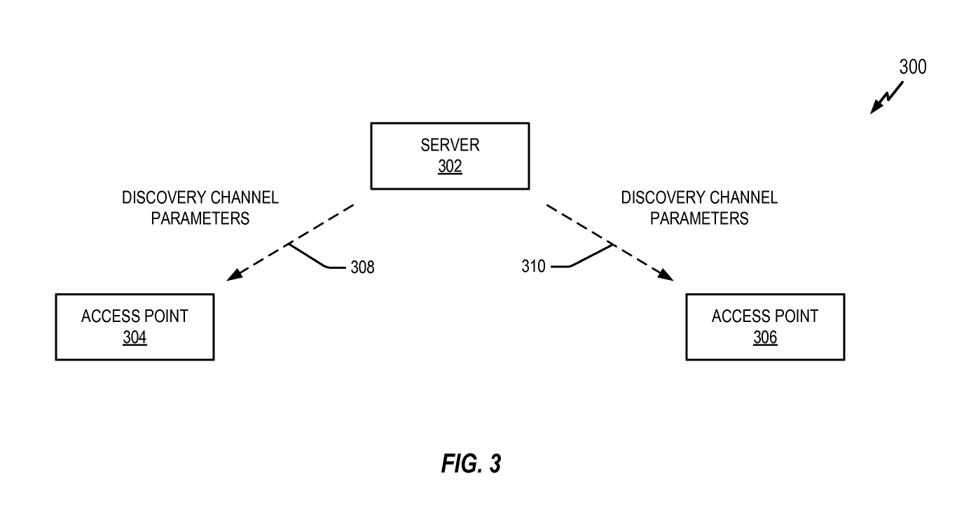

FIG. 3 illustrates an example of a communication network 300 where a server 302 (e.g., comprising a configuring manager) selects the parameters to be used for the discovery channels for access points served by the server 302. For example, the server 302 may select a first set of discovery channel parameters to be used by a first access point 304 and second set of discovery channel parameters to be used by a second access point 306. The server may then transmit both sets of discovery channel parameters to the first access point 304 via a first communication channel 308 and to the second access point 308 via a second communication channel 310. In this way, each of the first and second access point 304 and 306 will be configured to transmit discovery beacons and otherwise communicate on its respective discovery channel and to receive discovery beacons from and otherwise communicate with other access points in the communication network 300.

To reduce the complexity of FIG. 3, only a single server and two access points are represented in the figure. In practice, a communication network may employ more servers, access points, and other components.

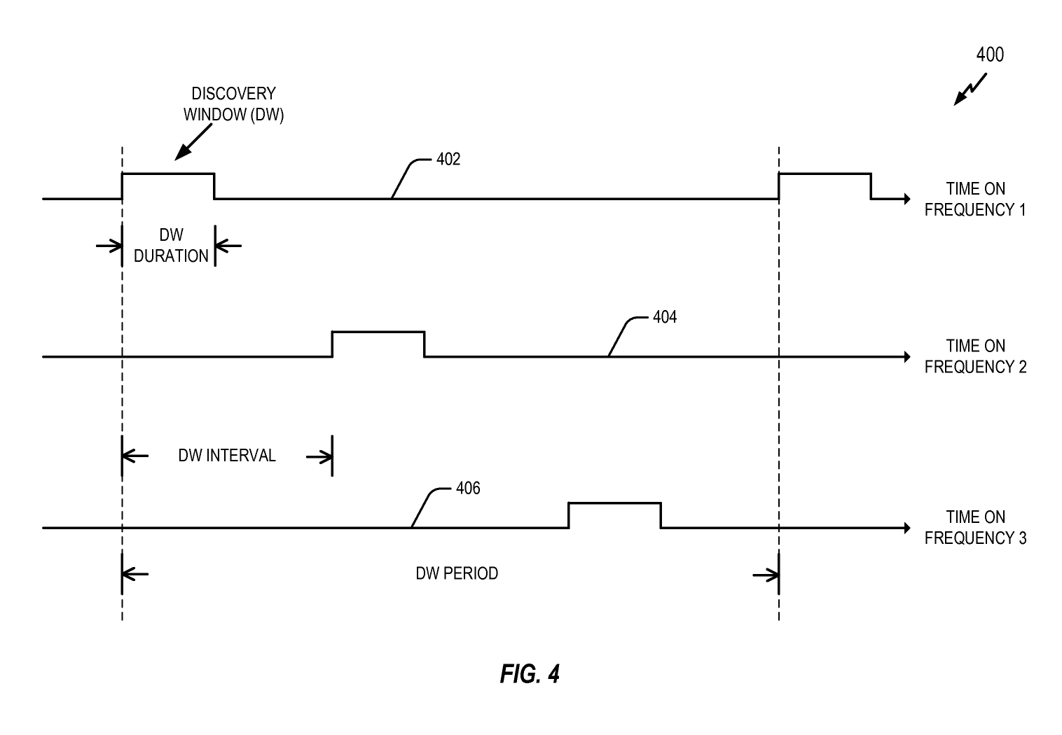

FIG. 4 illustrates an example of a discovery channel 400. In some aspects, a discovery channel may comprise a logical control channel, which consists of physical resources commonly agreed by all access points that will communicate via the channel.

As illustrated by waveforms 402, 404, and 406 in FIG. 4, a discovery channel may have multiple channels at different frequencies. In some cases, the channel may preferably be in an unlicensed band. Consequently, the channel might not interfere with any operation channels of existing systems (e.g., Wi-Fi, Bluetooth, cellular, etc.).

The time in FIG. 4 is partitioned into multiple periods. In each period, access points can send discovery beacons in any of the discovery windows at different times.

Discovery windows per period can hop across different frequency channels. In this way, the discovery channel may be prevented from being constantly jammed on one frequency channel.

The discovery channel may be specified via, for example, one or more of the following parameters: a discovery window (DW) period, a number of discovery windows per period, a number of frequency hopping channels per period, the frequency (e.g., center or nominal carrier frequency) of each hopping channel, the discovery window interval, the discovery window duration, or the bandwidth of each frequency hopping channel.

A high-level example of operations on a discovery channel follows. For purposes of illustration, these operations may be described as being performed by an access point. It should be appreciated, however, that these operations may be performed by other entities.

In a first step of the sample operations, an access point tunes to a discovery window (DW) for transmitting and receiving discovery beacons. To this end, the access point may employ, for example, the following hardware configuration options. In some implementations, the access point has a dedicated receiver and transmitter on the discovery channel. In this case, both transmitter and receiver are always tuned to every discovery window. In some implementations, the access point has a receiver and transmitter shared with those for the access point's traffic on an operating channel. In this case, both the transmitter and receiver are tuned to each discovery window if there is no unfinished traffic on the operating channel before tuning.

In a second step of the sample operations, if tuned to a discovery window, the transmitter (e.g., a transmitting node) will decide to transmit a discovery beacon with a certain probability. Transmission probability can be optimized to prevent high loading and/or a high collision rate. Alternatively, the transmitter can decide to transmit based on a minimum transmission interval, which controls the transmission activities. In some implementations, the beacon transmission will be based on carrier sense multiple access (CSMA). In addition, the transmission and reception time per access point within a discovery window can also be scheduled by a configuring manager.

Potential contents in a discovery beacon are set forth in Table 1. The first column describes several examples of information regarding the access point (AP) that transmitted the discovery beacon that may be included in the discovery beacon. The second column describes, for each entry in the first column, potential uses of the information of that entry.

TABLE 1

| Information of transmitting AP | Use case examples |
|---|---|
| AP transmit (Tx) power on | For other APs to estimate path loss |
| operating and discovery channels | based on received signal strength |
| | indication (RSSI) and optimize their |
| | transmit power on their operation |
| | channels |
| AP operating channel number | For other APs to optimize operating |
| | channel number and transmit power |
| AP primary channel number | For other APs to set their primary |
| | channels |
| AP's cell-edge preferred sub- | For multiplexing edge users from |
| band/time slot | different APs on orthogonal sub- |
| | band/time slot |
| Restricted access window (RAW) | For scheduling low modulation and |
| schedule | coding scheme (MCS) or low signal |
| | to interference and noise ratio |
| | (SINR) users in the RAW time |
| | window |
| AP location coordinates | For other APs to estimate AP |
| | density and tune coverage |
| AP's hearable neighboring AP list | For other APs to detect co-channel |
| | hidden APs |
| AP's receive (Rx) sensitivity level | For other APs to predict the impact |
| and noise floor | of caused interference |
| AP's SSID and BSSID | For other APs to identify the |
| | transmitting AP |
| AP's Internet protocol (IP) address | For other APs to setup IP |
| | connection and communicate with |
| | the transmitting AP via backhaul |

In a third step of the sample operations, if tuned to a discovery window, the transmitter may decide to transmit a unicast packet to another access point in its wireless range. The unicast packet could be a request/response frame for additional information. The transmitter can learn packet error rate based on an acknowledgement (ACK) from the other access point.

Synchronization may be employed to enable access points to tune to a discovery channel at the right time. Such synchronization may be achieved in various ways. In some implementations, access points can use an external timing source (e.g., cellular, GPS, or internet time server) for synchronization. In some implementations, a configuring manager can periodically send out synchronization frames to other access points in its managed zone for timing calibration.

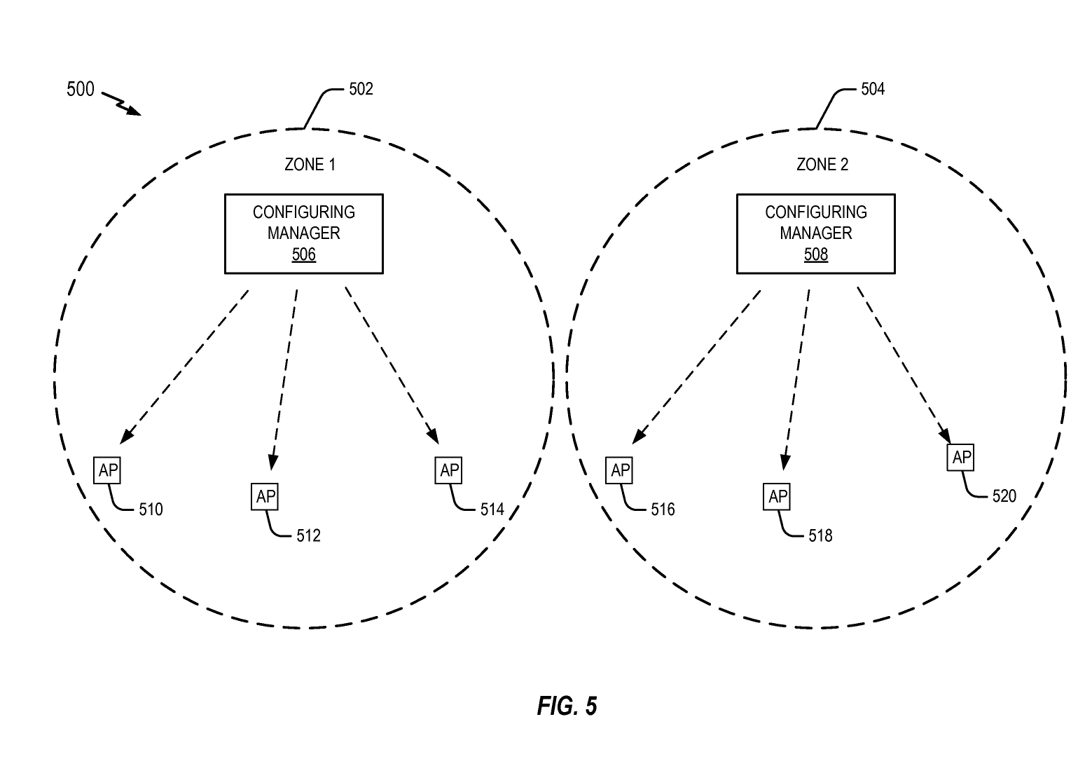

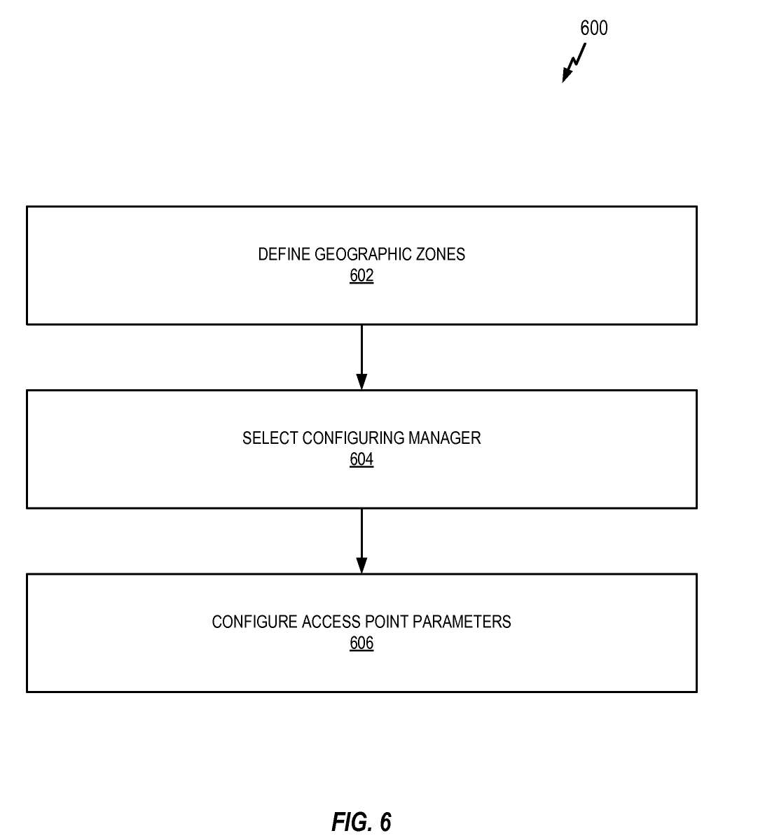

Referring to FIGS. 5 and 6, the various nodes (e.g., access points) in a communication network can be split into non-overlapping geographic zones. FIG. 5 illustrates a communication network 500 that includes a first zone 502 (zone 1) and a second zone 504 (zone 2). In this example, each zone 502 or 504 includes a configuring manager 506 or 508, respectively, for managing the discovery channels in that zone. Specifically, the configuring manager 506 configures discovery channels for access points (e.g., access points 510, 512, and 514) in the first zone 502. Similarly, the configuring manager 508 configures discovery channels for access points (e.g., access points 516, 518, and 520) in the second zone 504.

The configuration of a control channel (e.g., discovery channel) configuration and the operating parameters for a node can be optimized per zone based on certain information per zone. Several examples of this configuration and/or optimization information follow. One or more of these types of configuration and/or optimization information may be used to configure a channel and/or a node's operating parameters.

In some aspects, the configuration and/or optimization information relates to (e.g., comprises) the total number of nodes per zone. If there are a large number of nodes in a zone, channel parameters (e.g., for a discovery channel or an operating channel) may be selected in a manner that reduces the interference between channels. For example, one or more of lower transmit power, additional frequency hopping, additional channel frequencies, and so on may be employed to reduce the likelihood of inter-discovery channel interference. Additional examples of parameter optimization to mitigate interference and/or other issues are discussed below.

In some aspects, the configuration and/or optimization information relates to (e.g., comprises) the node density per zone. For example, if there is a high density of nodes in a certain area of a zone, channel parameters (e.g., for a discovery channel or an operating channel) may be selected in a manner that reduces the interference between channels in that area.

In some aspects, the configuration and/or optimization information relates to (e.g., comprises) the number of neighboring nodes observed by a node. For example, if a particular node has a large number of neighbors, channel parameters (e.g., for a discovery channel or an operating channel) may be selected in a manner that reduces the interference between channels in the vicinity of that particular node. Alternatively, or in addition, such a configuration decision can be based on the number of nodes observed by an access terminal and reported to a configuring manager (e.g., via a serving access point).

In some aspects, the configuration and/or optimization information relates to (e.g., comprises) the size of packets used by a node on the control channel. This information may be indicated per frequency hopping channel. For example, if relatively large packets are seen on a discovery channel, channel parameters (e.g., for a discovery channel or an operating channel) may be selected in a manner that reduces the interference between channels in the vicinity of that particular node or that reduces packet traffic on the discovery channel.

In some aspects, the configuration and/or optimization information relates to (e.g., comprises) a packet error rate on the control channel. This information may be indicated per frequency hopping channel. For example, if a relatively high packet error rate is seen on a discovery channel, channel parameters (e.g., for a discovery channel or an operating channel) may be selected in a manner that reduces the interference between channels in the vicinity of that particular node or that otherwise reduces the error rate on the discovery channel.

In some aspects, the configuration and/or optimization information relates to (e.g., comprises) the total load and/or the interference load observed by a node on the control channel. For example, if relatively high loading or interference are seen on a discovery channel, channel parameters (e.g., for a discovery channel or an operating channel) may be selected in a manner that reduces the interference between channels in the vicinity of that particular node or that reduces loading on the discovery channel. The configuration and/or optimization information may be indicated per frequency hopping channel. Total load may be defined as the percentage of time that the channel is sensed as busy by the node. Interference load may be defined as the percentage of time that the channel is sensed as busy due to non-node interference.

In some aspects, the configuration and/or optimization information relates to (e.g., comprises) the total load observed by a node on its operating channel. Alternatively, or in addition, an access terminal (STA) served by the node can report its observed total load to a configuring manager. If relatively high loading is seen on an operating channel, channel parameters (e.g., for a discovery channel or an operating channel) may be selected in a manner that reduces the loading on the operating channel.

One or more configuring managers can be assigned to process the above information and send out optimized configuration and operating parameters to nodes in each zone. A configuring manager may be, for example, a node (e.g., access point), a server, or some type of network entity. A given configuring manager can manage multiple zones or a single zone.

In the absence of central configuring managers, other options may be used to determine discovery channel configuration. Two examples of such options follow.

A first option involves a factory determined configuration. Here, each access point is factory configured with discovery channel parameters. In some implementations, the channel may be one or a subset of 1 MHz physical channels in IEEE 802.11ah band with a pre-determined frequency hopping pattern. Other examples of possible pre-determined configurations follow. Some implementations may employ low rate 802.11ah PHY transmission mode in 2.4/5 GHz band (e.g.: 1 MHz or 2 MHz or 4 MHz or 8 MHz transmission). Some implementations may employ low rate 802.11 of PHY transmission mode in the 2.4/5 GHz band (e.g.: 5 MHz or 10 MHz transmission). Some implementations may employ a low rate 802.11ah PHY transmission mode in the 11ah sub-1 GHz band (e.g.: 1 MHz or 2 MHz or 4 MHz or 8 MHz transmission). Some implementations may employ low rate 802.11 af PHY transmission mode in the television white space (TVWS) band (e.g.: 5 MHz or 10 MHz transmission).

A second option involves a negotiation-based configuration. Here, access points may determine discovery channel configuration by communicating, for example, over a pre-determined negotiation channel or via the backhaul. The negotiation channel may, for example, use the pre-determined configurations set forth above. Backhaul messages may, for example, use 802.11k, 802.11v, 802.11aa metrics to learn about neighboring access points (e.g., BSSID, MAC ID, IP address of each AP) and ping the access points.

In an example negotiation procedure, an AP suffering poor communication performance over the current discovery channel may indicate a candidate channel configuration to other access points. If most access points agree upon the new configuration, they will switch to the new configuration. Otherwise, the suffering access point can indicate another candidate channel configuration.

Several examples of parameter optimization for a discovery channel follow.

An access point's operating parameters can be optimized to prevent high packet collision rate and/or load on the discovery channel. For example, an access point may reduce its transmit power and/or rate on the discovery channel to reduce the rate of collisions and/or the loading. As another example, beacon transmission probability or transmission interval can be reduced or increased if the total load and/or collision rate is high in most discovery windows (e.g., as determined based on most access point's observations). As yet another example, an access point's CSMA parameters can be changed if the total load and/or collision rate is high (e.g., choose a larger minimum contention window (CWmin) and/or randomize the start of CSMA). As a further example, any change of the above probability and/or parameters can be further based on statistics (e.g., which can predict load and collision rate). Examples of such statistics include the number of neighboring access points observed by an access point, the total access points in a zone, the access point density in a zone, and the packet sizes used by the access points.

The configuration of the discovery channel can be optimized to prevent being affected by high interference. For example, the number of frequency hopping channels can be increased if interference load (e.g., defined above) is high in most discovery windows based on most access points' observations. As another example, the frequency of a given hopping channel can be changed if interference load is high on that channel in most discovery windows (e.g., as determined based on most access point's observations).

The configuration of the discovery channel can be optimized to limit the interruption to an access point's traffic on an operating channel in cases where the transmitter and receiver are shared between operating and discovery channels. In some aspects, the discovery window duration may be set small enough and/or the discovery window interval set long enough, so that for most access points the access point's tuning away time does not significantly reduce the access point's available load on its operating channel. For example, the discovery window duration can be set longer and the discovery window interval can be set shorter at night if most access points have light traffic on their operating channels at night. In this way, the access points can have more time for communications on the discovery channel at night, while reducing loading and interference on the operating channel during the day. Available load may be defined as being equal to: 100%−total load (e.g., load as defined above).

Referring now to FIG. 6, several example implementation details for a discovery channel follow. The implementation details include defining at least one geographic zone, selecting a configuring manager, and configuring access point parameters.

As represented by block 602 of FIG. 6, geographic zone definition may involve allocating different access points to non-overlapping geographic zones. Discovery channel configuration and access point operating parameters can be optimized per zone based on information (e.g., listed above) in that zone.

Geographic zones can be predefined and stored in a database. For example, zones can be defined based on zip code, or defined as non-overlapping rectangular zones with certain sizes. The defined zones can be stored in a database for an access point and/or server to check. A unique index may be assigned to each defined zone.

As represented by block 604, one or more configuring managers are selected for the zones defined at block 602. A configuring manager can be an access point or a server. For example, a server can be assigned to manage a particular zone. As another example, the first access point deployed in a zone may be designated as the configuring manager for that zone.

A configuring manager collects information, optimizes and sends out discovery channel configuration and access point operating parameters for access points in its managed zone. Information exchange with access points can be accomplished via a wireless network and/or a wired network.

A configuring manager may announce itself to (other) access points. The configuring manager may add itself to a configuring manager list in a database, which will be checked by other access points. The added information may include the configuring manager's MAC ID, IP address, and managed zone index.

As represented by block 606, the parameters for each of the access points in the zone are configured through the use of the configuration managers selected at block 604. For example, each access point (i.e., each non-configuring manager access point) may check the configuring manager list in the database to look for the configuring manager managing its zone.

Each of these access points can then send its identity information to the associated configuring manager. This information may include, for example, the access point's zone index, MAC ID, IP address, and service set identifier (SSID).

In response, the configuring manager may send out the default discovery channel configuration and access point operating parameters to the access point. Each configuring manager may coordinate with the configuring managers in neighboring zones to configure non-interfering discovery channels.

Next, the access point (and optionally a served access terminal) can periodically report measured metrics (e.g., listed above) to the configuring manager. The configuring manager may then optimize the discovery channel configuration and access point operating parameters based on this information (e.g., as described above).

A configuring manager can be reselected if the original configuring manager is missing (e.g., leaving the network or malfunctioning). This reselection may be achieved in various ways. For example, the original configuring manager can inform another node to take over its job before leaving the network, if possible. As another example, if a node (e.g., access point) cannot contact the configuring manager for a certain duration using the IP address in the database, the node may become the configuring manager and replace the old configuring manager's information with the node's corresponding information in the database.

A configuring manager will be removed or added, accordingly, if managed zones are merged or split. Configuring managers in the new zone(s) can be assigned based on negotiation between and/or decisions of old configuring managers, or assigned by a dedicated server.

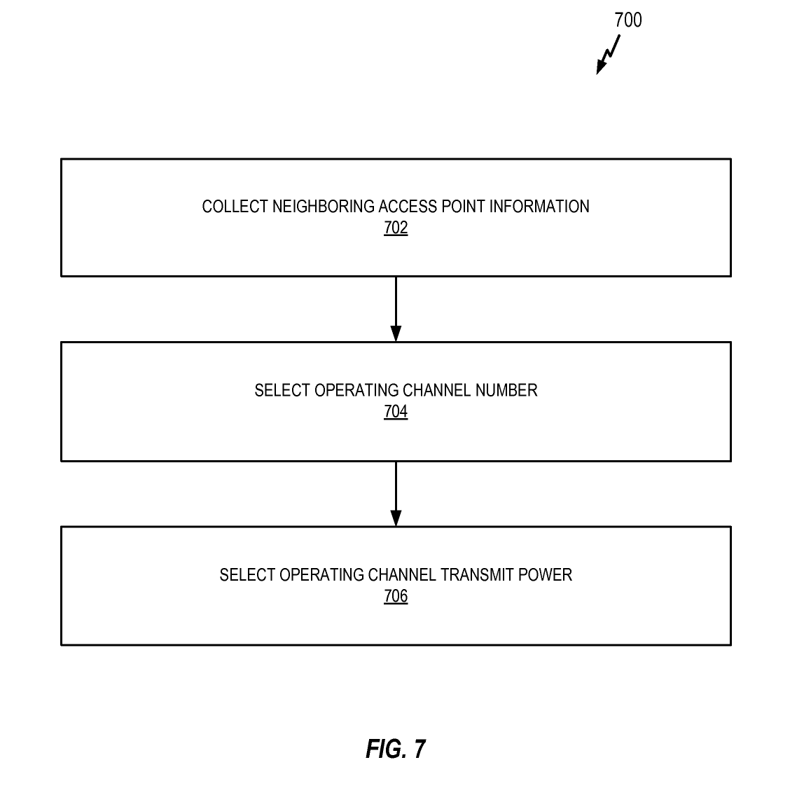

Referring to FIG. 7, an example of a use case of a discovery channel will be described in more detail. In this example, access point operating parameter selection is based on a prediction of caused interference. In some aspects, an access point autonomously selects operating parameters (e.g., transmit power and operating channel number) so that the caused interference is not significant at other access points. In addition, an access point predicts caused interference based on neighboring access points' information collected over the discovery channel. By using the discovery channel, the access point can discover and, hence, protect neighboring access points that have low transmit power (which may not be discovered over their operating channels). The use case involves three phases.

As represented by block 702 of FIG. 7, in the first phase, information about neighboring access points is collected. An optimizing access point acquires path loss and operating channel per neighboring access point hearable on the discovery channel.

Each access point sends discovery beacons over the discovery channel. In this example, the discovery beacon at least includes indications of the access point's transmit power on the discovery channel, operating channel number, and basic SSID (BSSID).

An optimizing access point estimates path loss to a neighboring access point based on its beacon RSSI and transmit power on the discovery channel.

As represented by block 704, in the second phase, an operating channel number is selected. An optimizing access point selects the operating channel number to minimize the maximum caused interference at nearby access points.

Assuming operation on channel “f” with transmit power “Txpwr”, the optimizing access point predicts caused interference at the i-th nearby access point in dB as follows: Intf(APᵢₜₕ, f)=Txpwr−PL(APⱼₜₕ)−Suppress(APᵢₜₕ). Here, PL(APⱼₜₕ) is the path loss to i-th nearby access point, and Suppress(APᵢₜₕ) is interference suppression due to operating channel spacing between the optimizing access point and i-th access point.

The optimizing access point picks the channel number “f” minimizing the maximum of caused interference across all nearby access points.

As represented by block 706, in the third phase, operating channel transmit power is selected. This phase involves a three-step process.

The first step involves co-channel protection. An optimizing access point's transmit power is first selected so that the caused interference at the closest co-channel nearby access point is equal to a threshold. Here, “closest” means minimum path loss.

The second step involves other-channel protection. The optimizing access point's transmit power will be further reduced if the maximum caused interference is greater than a threshold at nearby access points on other channels.

The third step involves STA UL link budget constraint.

The optimizing access point's transmit power will be further reduced if a STA has insufficient link budget to close the uplink (UL) at the downlink (DL) cell edge. Access point transmit power is further capped by TxpwrAP via solving: min_DL_SNR=TxpwrAP−PL−NoiseSTA. Here, PL is given by solving: min_UL_SNR=TxpwrSTA−PL−NoiseAP.

The optimizing access point may cap served STAs' transmit power as the access point's transmit power to prevent the STAs from jamming neighboring access points.

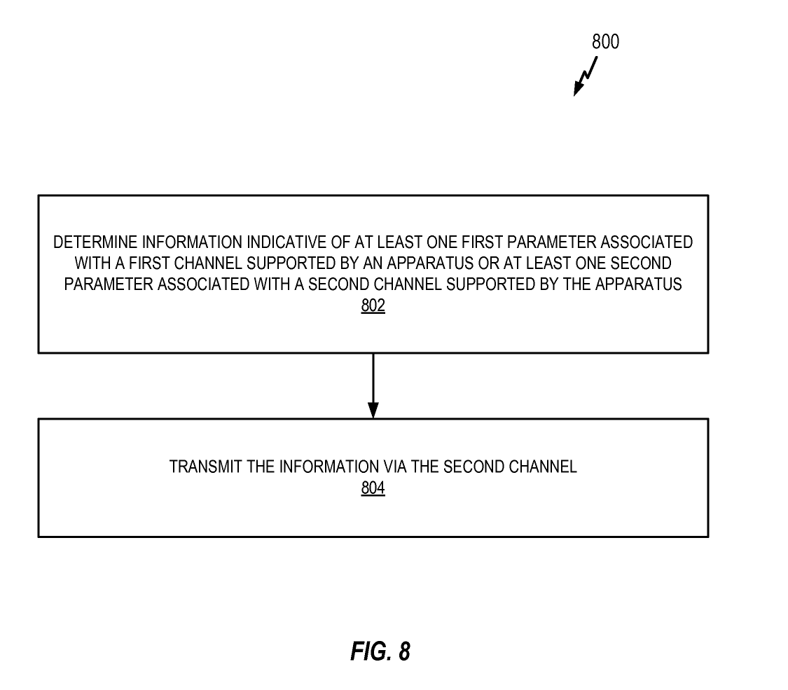

With the above in mind, examples of operations relating to an access point communication channel that may be performed in accordance with the teachings herein will be described in more detail with reference to FIGS. 8-12. For purposes of illustration, these operations may be described as being performed by a specific apparatus. It should be appreciated, however, that these operations may be performed by different types of apparatuses in different implementations.

Referring initially to FIG. 8, in some aspects, this flowchart describes sample operations that may be performed by a first apparatus in conjunction with communicating via a channel. In some implementations, the first apparatus may embody an access point or some other suitable type of node.

As represented by block 802, information indicative of at least one first parameter associated with a first channel supported by an apparatus or at least one second parameter associated with a second channel supported by the apparatus is determined. For example, the apparatus may retrieve parameter information from a memory device.

In some aspects, the first channel may be an operating channel and the second channel may be a discovery channel. In some aspects, the discovery channel may be associated with a first communication range that is longer than a second communication range associated with the operating channel.

The information may take different forms in different implementations. In some aspects, the at least one first parameter may indicate transmit power used by the apparatus on the first channel and the at least one second parameter may indicate transmit power used by the apparatus on the second channel. In some aspects, the information may indicate at least one identifier of the apparatus. In some aspects, the information may indicate a primary channel (e.g., a primary Wi-Fi channel) of the apparatus.

As represented by block 804, the information is transmitted via the second channel. For example, the apparatus may transmit the information via a long-range discovery channel.

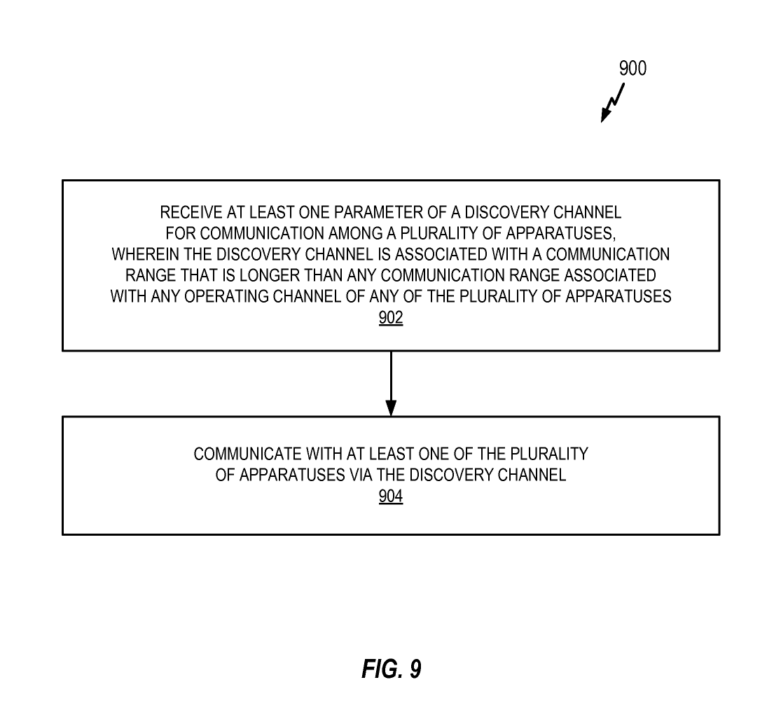

Referring to FIG. 9, in some aspects, this flowchart describes sample operations that may be performed by a first apparatus in conjunction with communicating via a channel. In some implementations, the first apparatus may embody an access point or some other suitable type of node.

As represented by block 902, at least one parameter of a discovery channel for communication among a plurality of apparatuses is received (e.g., by a first apparatus of the plurality of apparatuses). In some implementations, the plurality of apparatuses comprise a plurality of access points.

In some cases, the reception of the at least one parameter involves configuration of the first apparatus via a manufacturing device. In particular, the discovery channel per apparatus can be configured in a factory in some cases. For example, when an apparatus is constructed at the factory, the channel can be configured with a set of physical frequency channels with a pre-determined frequency hopping pattern.

In some aspects, the at least one parameter may comprise at least one of: a communication window duration, a communication window periodicity, a communication window interval, a quantity of communication windows per period, a quantity of frequency hopping channels per period, a radio frequency of a frequency hopping channel, or a bandwidth of a frequency hopping channel.

In some aspects, the channel may comprise a discovery channel associated with a communication range that is longer than a communication range associated with any operating channel of any of the plurality of apparatuses. In some aspects, the discovery channel may be associated with a channel frequency that is different from any channel frequency associated with any operating channel of any of the plurality of apparatuses. In some aspects, the discovery channel may be established in an unlicensed band.

As represented by block 904, communication with at least one of the plurality of apparatuses is accomplished via the discovery channel. In some aspects, this communication employs the at least one parameter received at block 902.

In some aspects, the communication via the discovery channel may comprise communicating (e.g., transmitting and/or receiving) at least one indication of: transmit power used by an apparatus on the radio frequency channel, transmit power used by an apparatus on an operating channel, operating channel number for an apparatus, primary channel number for an apparatus, cell-edge preferred sub-band for an apparatus, cell-edge preferred time slot for an apparatus, restricted access window schedule for an apparatus, location coordinates for an apparatus, list of neighboring access points hearable by an apparatus, receiver sensitivity level for an apparatus, receiver noise floor for an apparatus, service set identifier (SSID) for an apparatus, basis service set identifier (BSSID) for an apparatus, or Internet Protocol address for an apparatus.

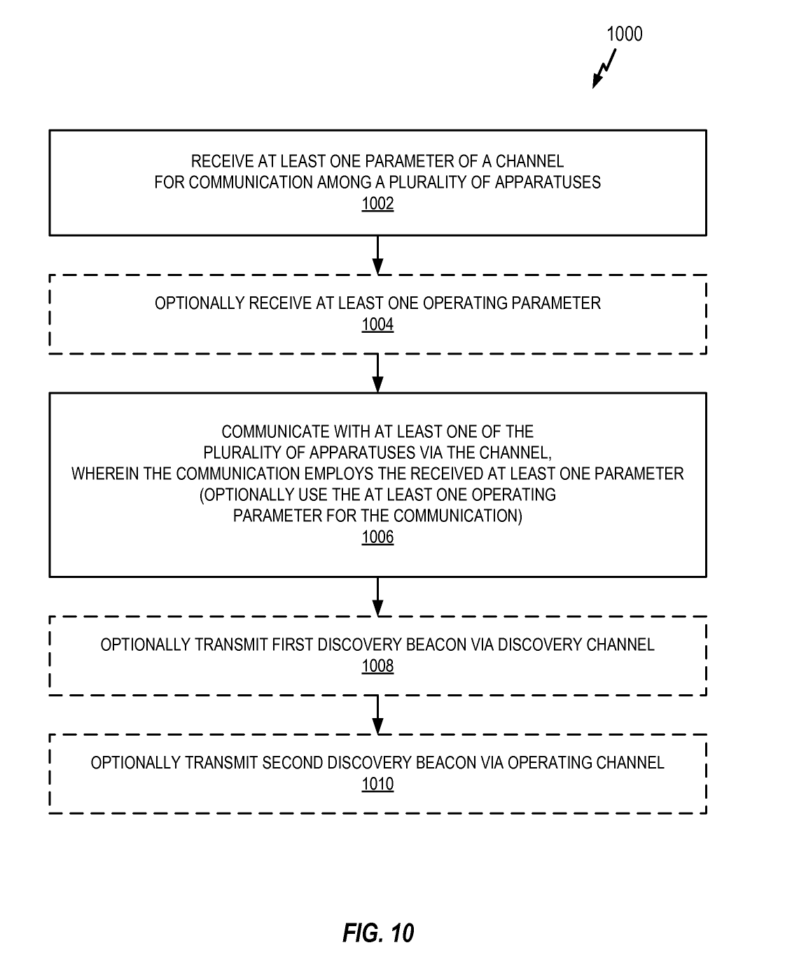

Referring to FIG. 10, this flowchart describes additional operations that may be performed by a first apparatus in conjunction with communicating via a channel. In some implementations, the first apparatus may embody an access point or some other suitable type of node.

As represented by block 1002, at least one parameter of a channel for communication among a plurality of apparatuses is received (e.g., by a first apparatus of the plurality of apparatuses). In some aspects, the operations of block 1002 may correspond to the operations of block 902 discussed above.

As represented by optional block 1004, at least one operating parameter is received. For example, the first apparatus may receive an operating parameter from a configuring manager, an access point or some other apparatus.

In some aspects, the at least one operating parameter may comprise at least one of: a parameter that controls transmission activity during a communication window or a parameter that specifies a size of a contention window. As an example of the former parameter, such an operating parameter may limit the transmission activity during a communication window (e.g., the parameter may indicate a probability of transmission and/or indicate how frequently transmission is conducted). In some aspects, such an operating parameter may function to limit the amount of time that the first apparatus can transmit on the channel. For example, the operating parameter could specify the amount of time the first apparatus is allowed to transmit in a given time period, etc.

In some aspects, the at least one operating parameter may comprise scheduling information that specifies transmit and receive timing for each of the plurality of apparatuses during a communication window. For example, instead of doing CSMA in each communication window, transmission and reception on the discovery channel by each apparatus may be scheduled by a configuring manager (e.g., the manager can determine the exact time and/or frequency for each apparatus's transmission and/or reception).

As represented by block 1006, communication with at least one of the plurality of apparatuses is accomplished via the channel. In some aspects, the operations of block 1006 may correspond to the operations of block 904 discussed above.

As represented by optional blocks 1008 and 1010, in some implementations, a first discovery beacon (e.g., a first type of discovery beacon) is transmitted via the (discovery) channel and a second discovery beacon (e.g., a second type of discovery beacon) is transmitted via an operating channel (e.g., of the first apparatus). In some aspects, the first discovery beacon comprises an indication of the operating channel, the first discovery beacon also comprises an indication of transmission power used on the discovery channel, and the second discovery beacon comprises an indication of transmission power used on the operating channel.

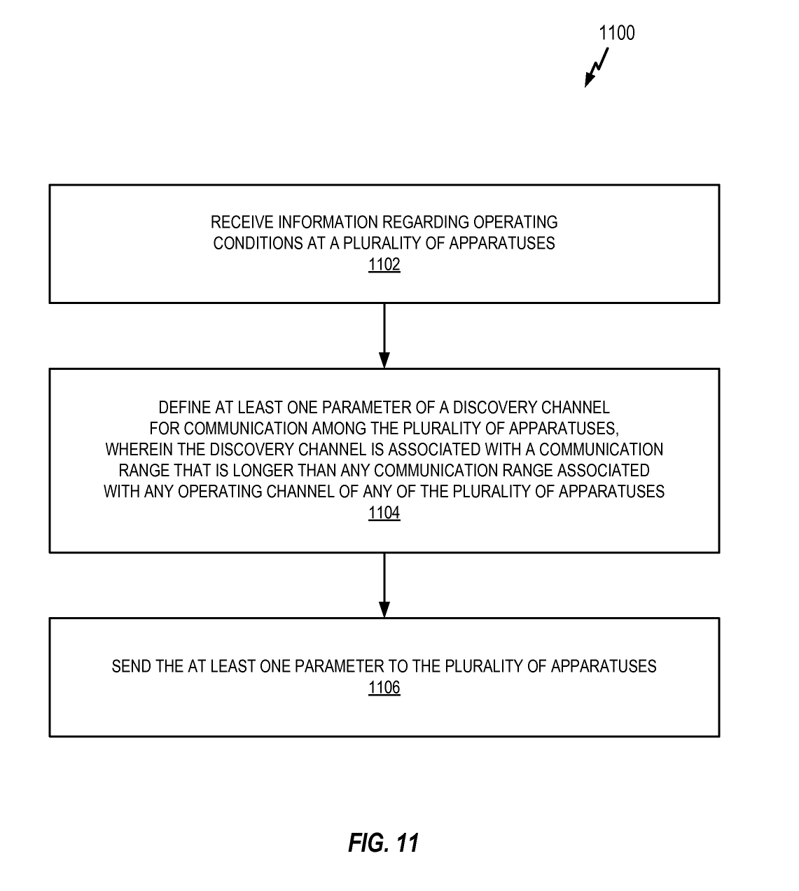

Referring to FIG. 11, in some aspects, this flowchart describes sample operations that may be performed by a first apparatus in conjunction with defining a channel. In some implementations, the first apparatus may embody (e.g., include, be implemented as, or be implemented within) an access point or some other suitable type of node (e.g., a network entity), while the other apparatuses may embody another access point or some other suitable type of node. In some aspects, the first apparatus may comprise a configuring manager.

As represented by block 1102, information regarding operating conditions at a plurality of apparatuses is received. In some aspects, the operating conditions may comprise loading on the channel. In some aspects, the operating conditions may comprise interference on the channel. In some aspects, the operating conditions may comprise operating channel loading experienced by at least one of the plurality of apparatuses. In some aspects, the operating conditions may comprise operating channel interference experienced by at least one of the plurality of apparatuses. In some aspects, the operating conditions may comprise at least one of: a quantity of apparatuses within a defined discovery zone, a density of apparatuses within a defined discovery zone, a quantity of apparatuses (e.g., access points) detected by at least one of the plurality of apparatuses on the radio frequency channel, a packet size employed by at least one of the plurality of apparatuses on the radio frequency channel, or a packet error rate experienced by at least one of the plurality of apparatuses on the radio frequency channel.

As represented by block 1104, at least one parameter of a discovery channel for communication among the plurality of apparatuses is defined based on the information received at block 1102. In some aspects, the discovery channel is associated with a communication range that is longer than any communication range associated with any operating channel of any of the plurality of apparatuses. In some aspects, the discovery channel may be associated with a channel frequency that is different from any channel frequency associated with any operating channel of any of the plurality of apparatuses. In some aspects, the discovery channel may be established in an unlicensed band. In some aspects, the at least one parameter may comprise at least one of: a communication window duration, a communication window periodicity, a communication window interval, a quantity of communication windows per period, a quantity of frequency hopping channels per period, a radio frequency of a frequency hopping channel, or a bandwidth of a frequency hopping channel.

As represented by block 1106, the at least one parameter is sent to the plurality of apparatuses. For example, a network entity may send a parameter to an access point via a backhaul or an access point may send a parameter to another access point via a backhaul or some other type of communication link.

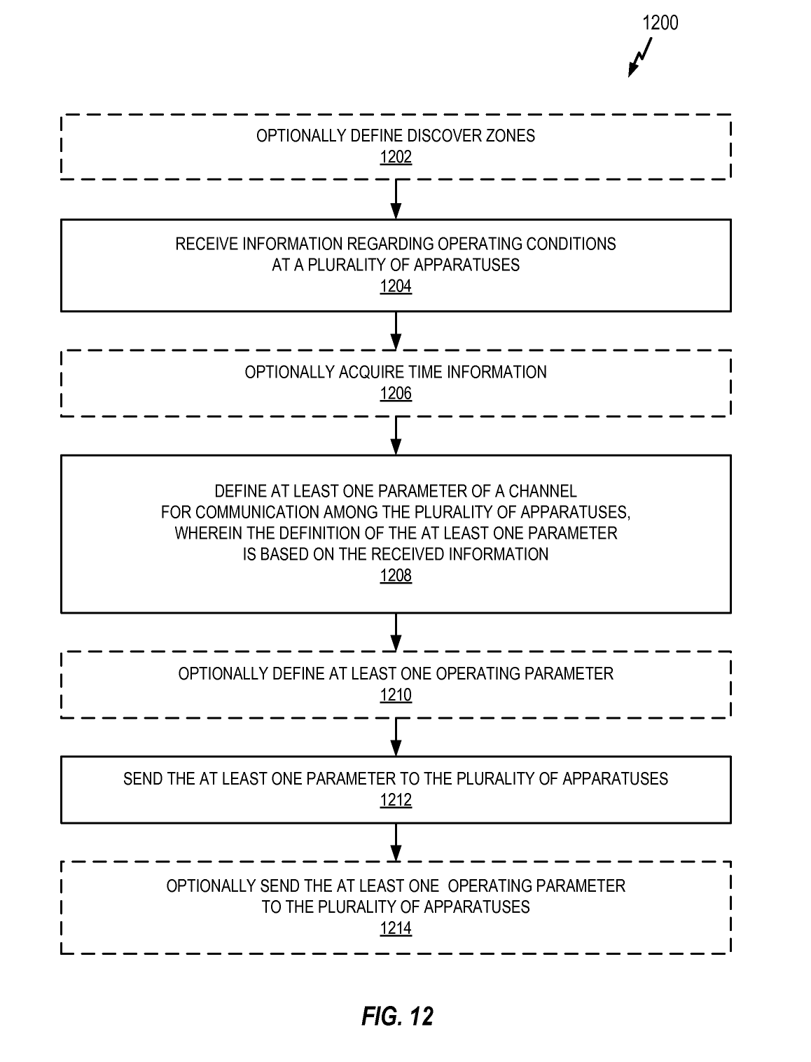

Referring to FIG. 12, this flowchart describes additional operations that may be performed by a first apparatus in conjunction with defining a channel. In some implementations, the first apparatus may embody an access point or some other suitable type of node (e.g., a network entity), while the other apparatuses may embody another access point or some other suitable type of node. In some aspects, the first apparatus may comprise a configuring manager.

As represented by optional block 1202, different discovery zones may be defined for different sets of apparatuses. For example, a first apparatus (or several apparatuses) may define a first discovery zone associated with a first channel for a first plurality of apparatuses and define a second discovery zone associated with a second channel for a second plurality of apparatuses. In some aspects, the defining of the first and second discovery zones is based on the first plurality of apparatuses and the second plurality of apparatuses being located in different geographical areas.

As represented by block 1204, information regarding operating conditions at a plurality of apparatuses is received. In some aspects, the operations of block 1204 may correspond to the operations of block 1102 discussed above.

As represented by optional block 1206, time information may be acquired. For example, timing information may be received via a network entity, a GPS receiver, or some other suitable timing source.

As represented by block 1208, at least one parameter of a channel for communication among the plurality of apparatuses is defined based on the information received at block 1204. In some aspects, the operations of block 1208 may correspond to the operations of block 1104 discussed above. Thus, in some aspects, the channel may comprise a discovery channel associated with a communication range that is longer than any communication range associated with any operating channel of any of the plurality of apparatuses.

The at least one parameter may optionally be defined based on time information acquired at block 1206. For example, different parameters may be employed at different times.

As represented by optional block 1210, at least one operating parameter for at least one of the plurality of apparatuses for communication via the channel may be defined. In some aspects, the definition of the at least one operating parameter may be based on the information received at block 1204.

In some aspects, the at least one operating parameter may comprise at least one of: a parameter that controls transmission activity during a communication window or a parameter that specifies a size of a contention window. As an example of the former parameter, such an operating parameter may limit the transmission activity during a communication window (e.g., the parameter may indicate a probability of transmission and/or indicate how frequently transmission is conducted). In some aspects, such an operating parameter may function to limit the amount of time that the first apparatus can transmit on the channel. For example, the operating parameter could specify the amount of time the first apparatus is allowed to transmit in a given time period, etc.

In some aspects, the at least one operating parameter may comprise scheduling information that specifies transmit and receive timing for each of the plurality of apparatuses during a communication window. For example, instead of doing CSMA in each communication window, transmission and reception on the discovery channel by each apparatus may be scheduled by a configuring manager (e.g., the manager can determine the exact time and/or frequency for each apparatus's transmission and/or reception).

As represented by block 1212, the at least one parameter is sent to the plurality of apparatuses. In some aspects, the operations of block 1212 may correspond to the operations of block 1106 discussed above.

As represented by optional block 1214, in implementations that employ block 1210, the at least one operating parameter also may be sent to the plurality of apparatuses.

As mentioned above, in some implementations, different channels may be established for different discovery zones. For example, the plurality of apparatuses and the channel referred to above may comprise a first plurality of apparatuses and a first channel associated with a first discovery zone, while a second plurality of apparatuses and a second channel are associated with a second discovery zone.

In some implementations, the different discovery zones may be defined by two different configuring managers. In such a case, parameter definitions may be negotiated among two configuring managers (e.g., to maintain orthogonalization). For example, if collision happens, each manager can generate a random number, and the manager with the smaller number will reconfigure the channel.

Accordingly, the method may comprise the first apparatus negotiating with another apparatus to define a first discovery zone associated with the first channel for the first plurality of apparatuses and to enable the other apparatus to define a second discovery zone associated with a second channel for a second plurality of apparatuses. In some aspects, the first apparatus may comprise a first configuring manager, and the other apparatus may comprise a second configuring manager. In some aspects, as a result of the negotiation, the at least one parameter for the first channel and at least one other parameter for the second channel are defined such that the first channel and the second channel are orthogonal.

In some implementations, the method may comprise the first apparatus: receiving other information regarding operating conditions at a second plurality of apparatuses; defining at least one other parameter of a second channel for communication among the second plurality of apparatuses, wherein the definition of the at least one other parameter is based on the received other information; and sending the at least one other parameter to the second plurality of apparatuses. In some aspects, the at least one parameter and the at least one other parameter may be defined such that the first channel and the second channel are orthogonal.

The teachings herein may be implemented using various wireless technologies. Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols.

In some aspects, wireless signals may be transmitted according to an 802.11 protocol using orthogonal frequency-division multiplexing (OFDM), direct-sequence spread spectrum (DSSS) communication, a combination of OFDM and DSSS communication, or other schemes.

Certain of the devices described herein may further implement Multiple Input Multiple Output (MIMO) technology and be implemented as part of an 802.11 protocol. A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels or streams, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In some implementations, a WLAN includes various devices that access the wireless network. For example, there may be two types of devices: access points (“APs”) and clients (also referred to as stations, or “STAs”). In general, an AP serves as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations, a STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

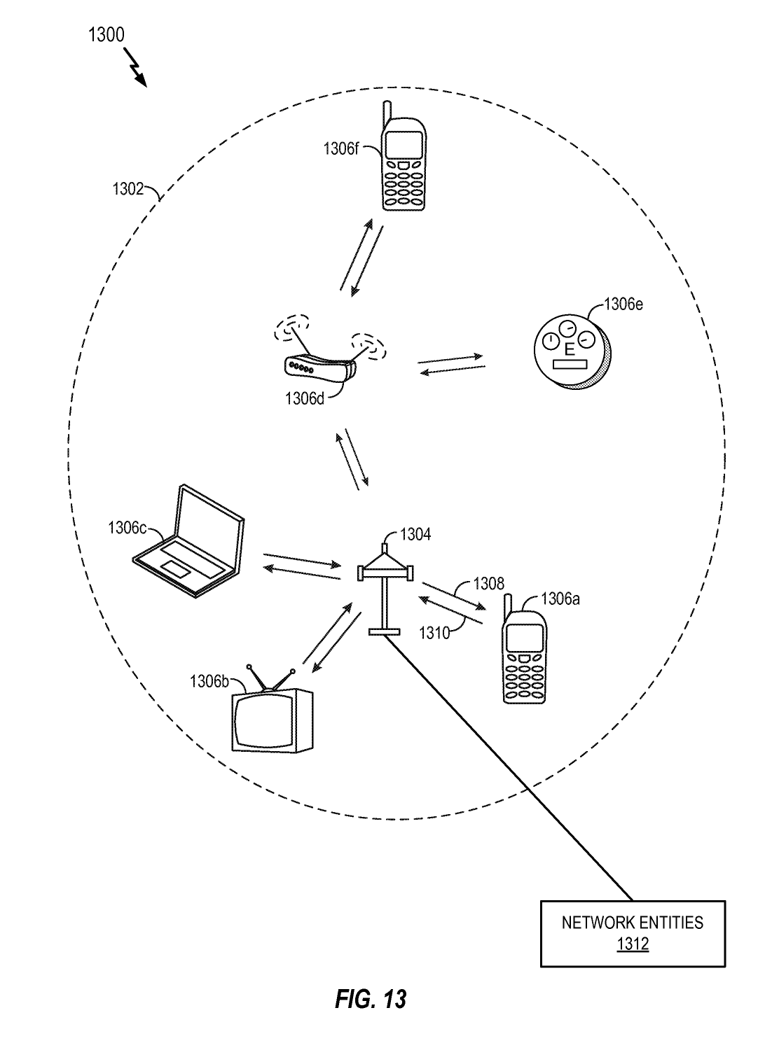

FIG. 13 illustrates an example of a wireless communication system 1300 in which aspects of the present disclosure may be employed. The wireless communication system 1300 may operate pursuant to a wireless standard, for example the 802.11 standard. The wireless communication system 1300 may include an AP 1304, which communicates with STAs 1306a, 1306b, 1306c, 1306d, 1306e, and 1306f (collectively STAs 1306).

STAs 1306e and 1306f may have difficulty communicating with the AP 1304 or may be out of range and unable to communicate with the AP 1304. As such, another STA 1306d may be configured as a relay device (e.g., a device comprising STA and AP functionality) that relays communication between the AP 1304 and the STAs 1306e and 1306f.

A variety of processes and methods may be used for transmissions in the wireless communication system 1300 between the AP 1304 and the STAs 1306. For example, signals may be sent and received between the AP 1304 and the STAs 1306 in accordance with OFDM/OFDMA techniques. If this is the case, the wireless communication system 1300 may be referred to as an OFDM/OFDMA system. Alternatively, signals may be sent and received between the AP 1304 and the STAs 1306 in accordance with CDMA techniques. If this is the case, the wireless communication system 1300 may be referred to as a CDMA system.

A communication link that facilitates transmission from the AP 1304 to one or more of the STAs 1306 may be referred to as a downlink (DL) 1308, and a communication link that facilitates transmission from one or more of the STAs 1306 to the AP 1304 may be referred to as an uplink (UL) 1310. Alternatively, a downlink 1308 may be referred to as a forward link or a forward channel, and an uplink 1310 may be referred to as a reverse link or a reverse channel.

The AP 1304 may act as a base station and provide wireless communication coverage in a basic service area (BSA) 1302. The AP 1304 along with the STAs 1306 associated with the AP 1304 and that use the AP 1304 for communication may be referred to as a basic service set (BSS).

Access points may thus be deployed in a communication network to provide access to one or more services (e.g., network connectivity) for one or more access terminals that may be installed within or that may roam throughout a coverage area of the network. For example, at various points in time an access terminal may connect to the AP 1304 or to some other access point in the network (not shown).

Each of the access points may communicate with one or more network entities (represented, for convenience, by network entities 1312 in FIG. 13), including each other, to facilitate wide area network connectivity. A network entity may take various forms such as, for example, one or more radio and/or core network entities. Thus, in various implementations the network entities 1312 may represent functionality such as at least one of: network management (e.g., via an authentication, authorization, and accounting (AAA) server), session management, mobility management, gateway functions, interworking functions, database functionality, or some other suitable network functionality. Two or more of such network entities may be co-located and/or two or more of such network entities may be distributed throughout a network.

It should be noted that in some implementations the wireless communication system 1300 may not have a central AP 1304, but rather may function as a peer-to-peer network between the STAs 1306. Accordingly, the functions of the AP 1304 described herein may alternatively be performed by one or more of the STAs 1306. Also, as mentioned above, a relay may incorporate at least some of the functionality of an AP and a STA.

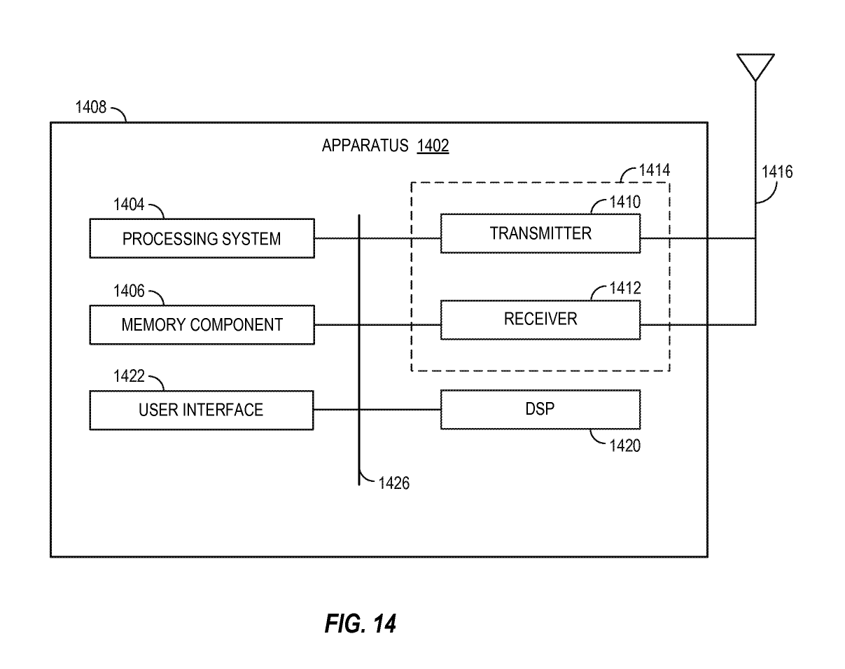

FIG. 14 illustrates various components that may be utilized in an apparatus 1402 (e.g., a wireless device) that may be employed within the wireless communication system 1300. The apparatus 1402 is an example of a device that may be configured to implement the various methods described herein. For example, the apparatus 1402 may comprise the AP 1304, a relay 1306d, or one of the STAs 1306 of FIG. 13.

The apparatus 1402 may include a processing system 1404 that controls operation of the apparatus 1402. The processing system 1404 may also be referred to as a central processing unit (CPU). A memory component 1406 (e.g., including a memory device), which may include both read-only memory (ROM) and random access memory (RAM), provides instructions and data to the processing system 1404. A portion of the memory component 1406 may also include non-volatile random access memory (NVRAM). The processing system 1404 typically performs logical and arithmetic operations based on program instructions stored within the memory component 1406. The instructions in the memory component 1406 may be executable to implement the methods described herein.

When the apparatus 1402 is implemented or used as a transmitting node, the processing system 1404 may be configured to select one of a plurality of media access control (MAC) header types, and to generate a packet having that MAC header type. For example, the processing system 1404 may be configured to generate a packet comprising a MAC header and a payload and to determine what type of MAC header to use.

When the apparatus 1402 is implemented or used as a receiving node, the processing system 1404 may be configured to process packets of a plurality of different MAC header types. For example, the processing system 1404 may be configured to determine the type of MAC header used in a packet and process the packet and/or fields of the MAC header.

The processing system 1404 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The apparatus 1402 may also include a housing 1408 that may include a transmitter 1410 and a receiver 1412 to allow transmission and reception of data between the apparatus 1402 and a remote location. The transmitter 1410 and receiver 1412 may be combined into single communication device (e.g., a transceiver 1414). An antenna 1416 may be attached to the housing 1408 and electrically coupled to the transceiver 1414. The apparatus 1402 may also include (not shown) multiple transmitters, multiple receivers, multiple transceivers, and/or multiple antennas. A transmitter 1410 and a receiver 1412 may comprise an integrated device (e.g., embodied as a transmitter circuit and a receiver circuit of a single communication device) in some implementations, may comprise a separate transmitter device and a separate receiver device in some implementations, or may be embodied in other ways in other implementations.

The transmitter 1410 may be configured to wirelessly transmit packets having different MAC header types. For example, the transmitter 1410 may be configured to transmit packets with different types of headers generated by the processing system 1404, discussed above.

The receiver 1412 may be configured to wirelessly receive packets having different MAC header type. In some aspects, the receiver 1412 is configured to detect a type of a MAC header used and process the packet accordingly.

The receiver 1412 may be used to detect and quantify the level of signals received by the transceiver 1414. The receiver 1412 may detect such signals as total energy, energy per subcarrier per symbol, power spectral density and other signals. The apparatus 1402 may also include a digital signal processor (DSP) 1420 for use in processing signals. The DSP 1420 may be configured to generate a data unit for transmission. In some aspects, the data unit may comprise a physical layer data unit (PPDU). In some aspects, the PPDU is referred to as a packet.

The apparatus 1402 may further comprise a user interface 1422 in some aspects. The user interface 1422 may comprise a keypad, a microphone, a speaker, and/or a display. The user interface 1422 may include any element or component that conveys information to a user of the apparatus 1402 and/or receives input from the user.

The various components of the apparatus 1402 may be coupled together by a bus system 1426. The bus system 1426 may include a data bus, for example, as well as a power bus, a control signal bus, and a status signal bus in addition to the data bus. Those of skill in the art will appreciate the components of the apparatus 1402 may be coupled together or accept or provide inputs to each other using some other mechanism.

Although a number of separate components are illustrated in FIG. 14, one or more of the components may be combined or commonly implemented. For example, the processing system 1404 may be used to implement not only the functionality described above with respect to the processing system 1404, but also to implement the functionality described above with respect to the transceiver 1414 and/or the DSP 1420. Further, each of the components illustrated in FIG. 14 may be implemented using a plurality of separate elements. Furthermore, the processing system 1404 may be used to implement any of the components, modules, circuits, or the like described below, or each may be implemented using a plurality of separate elements.

For ease of reference, when the apparatus 1402 is configured as a transmitting node, it is hereinafter referred to as an apparatus 1402t. Similarly, when the apparatus 1402 is configured as a receiving node, it is hereinafter referred to as an apparatus 1402r. A device in the wireless communication system 1300 may implement only functionality of a transmitting node, only functionality of a receiving node, or functionality of both a transmitting node and a receive node.

As discussed above, the apparatus 1402 may comprise an AP 1304 or a STA 1306, and may be used to transmit and/or receive communication having a plurality of MAC header types.

The components of FIG. 14 may be implemented in various ways. In some implementations, the components of FIG. 14 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks of FIG. 14 may be implemented by processor and memory component(s) of the apparatus (e.g., by execution of appropriate code and/or by appropriate configuration of processor components). It should be appreciated that these components may be implemented in different types of apparatuses in different implementations (e.g., in an ASIC, in a system-on-a-chip (SoC), etc.).

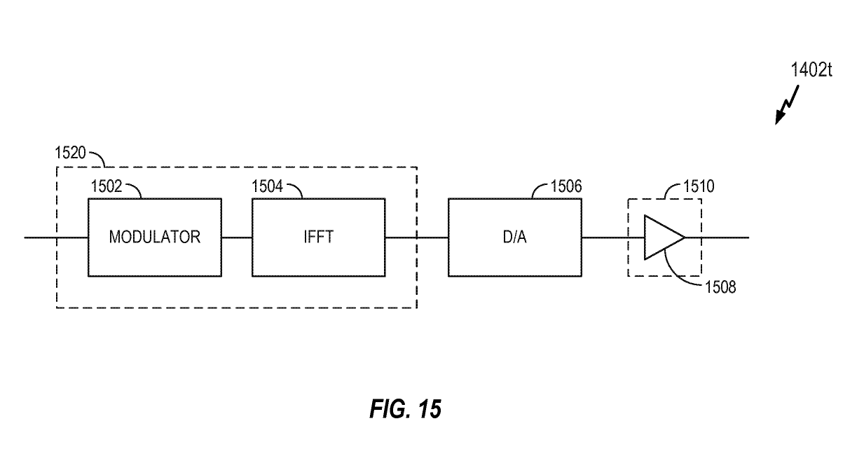

As discussed above, the apparatus 1402 may comprise an AP 1304 or a STA 1306, a relay, or some other type of apparatus, and may be used to transmit and/or receive communication. FIG. 15 illustrates various components that may be utilized in the apparatus 1402t to transmit wireless communication. The components illustrated in FIG. 15 may be used, for example, to transmit OFDM communication. In some aspects, the components illustrated in FIG. 15 are used to generate and transmit packets to be sent over a bandwidth of less than or equal to 1 MHz.

The apparatus 1402t of FIG. 15 may comprise a modulator 1502 configured to modulate bits for transmission. For example, the modulator 1502 may determine a plurality of symbols from bits received from the processing system 1404 (FIG. 14) or the user interface 1422 (FIG. 14), for example by mapping bits to a plurality of symbols according to a constellation. The bits may correspond to user data or to control information. In some aspects, the bits are received in codewords. In one aspect, the modulator 1502 comprises a QAM (quadrature amplitude modulation) modulator, for example a 16-QAM modulator or a 64-QAM modulator. In other aspects, the modulator 1502 comprises a binary phase-shift keying (BPSK) modulator or a quadrature phase-shift keying (QPSK) modulator.

The apparatus 1402t may further comprise a transform module 1504 configured to convert symbols or otherwise modulated bits from the modulator 1502 into a time domain. In FIG. 15, the transform module 1504 is illustrated as being implemented by an inverse fast Fourier transform (IFFT) module. In some implementations, there may be multiple transform modules (not shown) that transform units of data of different sizes. In some implementations, the transform module 1504 may be itself configured to transform units of data of different sizes. For example, the transform module 1504 may be configured with a plurality of modes, and may use a different number of points to convert the symbols in each mode. For example, the IFFT may have a mode where 32 points are used to convert symbols being transmitted over 32 tones (i.e., subcarriers) into a time domain, and a mode where 64 points are used to convert symbols being transmitted over 64 tones into a time domain. The number of points used by the transform module 1504 may be referred to as the size of the transform module 1504.

In FIG. 15, the modulator 1502 and the transform module 1504 are illustrated as being implemented in the DSP 1520. In some aspects, however, one or both of the modulator 1502 and the transform module 1504 are implemented in the processing system 1404 or in another element of the apparatus 1402t (e.g., see description above with reference to FIG. 14).

As discussed above, the DSP 1520 may be configured to generate a data unit for transmission. In some aspects, the modulator 1502 and the transform module 1504 may be configured to generate a data unit comprising a plurality of fields including control information and a plurality of data symbols.

Returning to the description of FIG. 15, the apparatus 1402t may further comprise a digital to analog converter 1506 configured to convert the output of the transform module into an analog signal. For example, the time-domain output of the transform module 1506 may be converted to a baseband OFDM signal by the digital to analog converter 1506. The digital to analog converter 1506 may be implemented in the processing system 1404 or in another element of the apparatus 1402 of FIG. 14. In some aspects, the digital to analog converter 1506 is implemented in the transceiver 1414 (FIG. 14) or in a data transmit processor.

The analog signal may be wirelessly transmitted by the transmitter 1510. The analog signal may be further processed before being transmitted by the transmitter 1510, for example by being filtered or by being upconverted to an intermediate or carrier frequency. In the aspect illustrated in FIG. 15, the transmitter 1510 includes a transmit amplifier 1508. Prior to being transmitted, the analog signal may be amplified by the transmit amplifier 1508. In some aspects, the amplifier 1508 comprises a low noise amplifier (LNA).

The transmitter 1510 is configured to transmit one or more packets or data units in a wireless signal based on the analog signal. The data units may be generated using the processing system 1404 (FIG. 14) and/or the DSP 1520, for example using the modulator 1502 and the transform module 1504 as discussed above. Data units that may be generated and transmitted as discussed above are described in additional detail below.

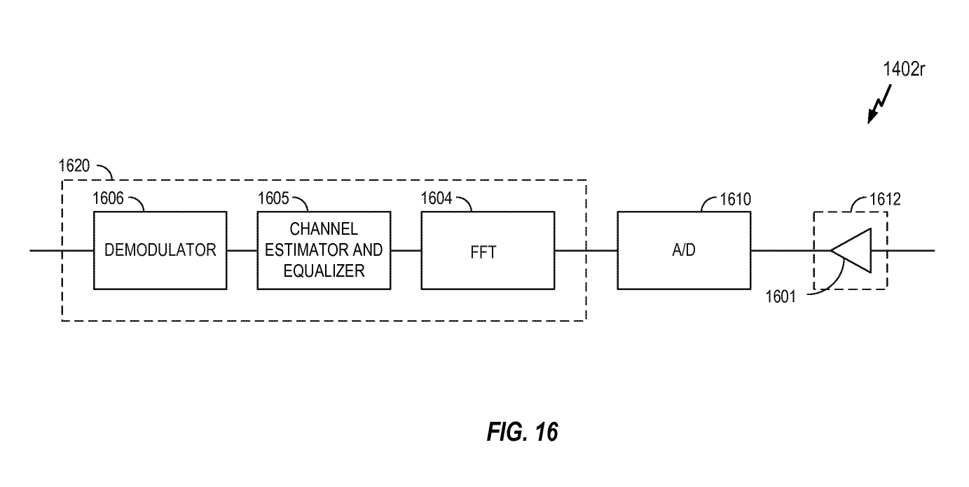

FIG. 16 illustrates various components that may be utilized in the apparatus 1402 of FIG. 14 to receive wireless communication. The components illustrated in FIG. 16 may be used, for example, to receive OFDM communication. For example, the components illustrated in FIG. 16 may be used to receive data units transmitted by the components discussed above with respect to FIG. 15.

The receiver 1612 of apparatus 1402r is configured to receive one or more packets or data units in a wireless signal. Data units that may be received and decoded or otherwise processed as discussed below.

In the aspect illustrated in FIG. 16, the receiver 1612 includes a receive amplifier 1601. The receive amplifier 1601 may be configured to amplify the wireless signal received by the receiver 1612. In some aspects, the receiver 1612 is configured to adjust the gain of the receive amplifier 1601 using an automatic gain control (AGC) procedure. In some aspects, the automatic gain control uses information in one or more received training fields, such as a received short training field (STF) for example, to adjust the gain. Those having ordinary skill in the art will understand methods for performing AGC. In some aspects, the amplifier 1601 comprises an LNA.

The apparatus 1402r may comprise an analog to digital converter 1610 configured to convert the amplified wireless signal from the receiver 1612 into a digital representation thereof. Further to being amplified, the wireless signal may be processed before being converted by the digital to analog converter 1610, for example by being filtered or by being downconverted to an intermediate or baseband frequency. The analog to digital converter 1610 may be implemented in the processing system 1404 (FIG. 14) or in another element of the apparatus 1402r. In some aspects, the analog to digital converter 1610 is implemented in the transceiver 1414 (FIG. 14) or in a data receive processor.

The apparatus 1402r may further comprise a transform module 1604 configured to convert the representation of the wireless signal into a frequency spectrum. In FIG. 16, the transform module 1604 is illustrated as being implemented by a fast Fourier transform (FFT) module. In some aspects, the transform module may identify a symbol for each point that it uses. As described above with reference to FIG. 15, the transform module 1604 may be configured with a plurality of modes, and may use a different number of points to convert the signal in each mode. The number of points used by the transform module 1604 may be referred to as the size of the transform module 1604. In some aspects, the transform module 1604 may identify a symbol for each point that it uses.

The apparatus 1402r may further comprise a channel estimator and equalizer 1605 configured to form an estimate of the channel over which the data unit is received, and to remove certain effects of the channel based on the channel estimate. For example, the channel estimator 1605 may be configured to approximate a function of the channel, and the channel equalizer may be configured to apply an inverse of that function to the data in the frequency spectrum.

The apparatus 1402r may further comprise a demodulator 1606 configured to demodulate the equalized data. For example, the demodulator 1606 may determine a plurality of bits from symbols output by the transform module 1604 and the channel estimator and equalizer 1605, for example by reversing a mapping of bits to a symbol in a constellation. The bits may be processed or evaluated by the processing system 1404 (FIG. 14), or used to display or otherwise output information to the user interface 1422 (FIG. 14). In this way, data and/or information may be decoded. In some aspects, the bits correspond to codewords. In one aspect, the demodulator 1606 comprises a QAM (quadrature amplitude modulation) demodulator, for example a 16-QAM demodulator or a 64-QAM demodulator. In other aspects, the demodulator 1606 comprises a binary phase-shift keying (BPSK) demodulator or a quadrature phase-shift keying (QPSK) demodulator.

In FIG. 16, the transform module 1604, the channel estimator and equalizer 1605, and the demodulator 1606 are illustrated as being implemented in the DSP 1620. In some aspects, however, one or more of the transform module 1604, the channel estimator and equalizer 1605, and the demodulator 1606 are implemented in the processing system 1404 (FIG. 14) or in another element of the apparatus 1402 (FIG. 14).

As discussed above, the wireless signal received at the receiver 1412 comprises one or more data units. Using the functions or components described above, the data units or data symbols therein may be decoded evaluated or otherwise evaluated or processed. For example, the processing system 1404 (FIG. 14) and/or the DSP 1620 may be used to decode data symbols in the data units using the transform module 1604, the channel estimator and equalizer 1605, and the demodulator 1606.

Data units exchanged by the AP 1304 and the STA 1306 may include control information or data, as discussed above. At the physical (PHY) layer, these data units may be referred to as physical layer protocol data units (PPDUs). In some aspects, a PPDU may be referred to as a packet or physical layer packet. Each PPDU may comprise a preamble and a payload. The preamble may include training fields and a SIG field. The payload may comprise a Media Access Control (MAC) header or data for other layers, and/or user data, for example. The payload may be transmitted using one or more data symbols. The systems, methods, and devices herein may utilize data units with training fields whose peak-to-power ratio has been minimized.

The apparatus 1402t shown in FIG. 15 shows an example of a single transmit chain to be transmitted over an antenna. The apparatus 1402r shown in FIG. 16 shows an example of a single receive chain to be received over an antenna. In some implementations, the apparatus 1402t or 1402r may implement a portion of a MIMO system using multiple antennas to simultaneously transmit data.

The wireless network 1300 may employ methods to allow efficient access of the wireless medium based on unpredictable data transmissions while avoiding collisions. As such, in accordance with various aspects, the wireless network 1300 performs carrier sense multiple access/collision avoidance (CSMA/CA) that may be referred to as the Distributed Coordination Function (DCF). More generally, an apparatus 1402 having data for transmission senses the wireless medium to determine if the channel is already occupied. If the apparatus 1402 senses the channel is idle then the apparatus 1402 transmits prepared data. Otherwise, the apparatus 1402 may defer for some period before determining again whether or not the wireless medium is free for transmission. A method for performing CSMA may employ various gaps between consecutive transmissions to avoid collisions. In an aspect, transmissions may be referred to as frames and a gap between frames is referred to as an Interframe Spacing (IFS). Frames may be any one of user data, control frames, management frames, and the like.

IFS time durations may vary depending on the type of time gap provided. Some examples of IFS include a Short Interframe Spacing (SIFS), a Point Interframe Spacing (PIFS), and a DCF Interframe Spacing (DIFS) where SIFS is shorter than PIFS, which is shorter than DIFS. Transmissions following a shorter time duration will have a higher priority than one that must wait longer before attempting to access the channel.

A wireless apparatus may include various components that perform functions based on signals that are transmitted by or received at the wireless apparatus. For example, in some implementations a wireless apparatus comprises a user interface configured to output an indication based on a received signal as taught herein.

A wireless apparatus as taught herein may communicate via one or more wireless communication links that are based on or otherwise support any suitable wireless communication technology. For example, in some aspects a wireless apparatus may associate with a network such as a local area network (e.g., a Wi-Fi network) or a wide area network. To this end, a wireless apparatus may support or otherwise use one or more of a variety of wireless communication technologies, protocols, or standards such as, for example, Wi-Fi, WiMAX, CDMA, TDMA, OFDM, and OFDMA. Also, a wireless apparatus may support or otherwise use one or more of a variety of corresponding modulation or multiplexing schemes. A wireless apparatus may thus include appropriate components (e.g., air interfaces) to establish and communicate via one or more wireless communication links using the above or other wireless communication technologies. For example, a device may comprise a wireless transceiver with associated transmitter and receiver components that may include various components (e.g., signal generators and signal processors) that facilitate communication over a wireless medium.

The teachings herein may be incorporated into (e.g., implemented within or performed by) a variety of apparatuses (e.g., nodes). In some aspects, an apparatus (e.g., a wireless apparatus) implemented in accordance with the teachings herein may comprise an access point, a relay, or an access terminal.

An access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

A relay may comprise, be implemented as, or known as a relay node, a relay device, a relay station, a relay apparatus, or some other similar terminology. As discussed above, in some aspects, a relay may comprise some access terminal functionality and some access point functionality.

In some aspects, a wireless apparatus comprises an access device (e.g., an access point) for a communication system. Such an access device provides, for example, connectivity to another network (e.g., a wide area network such as the Internet or a cellular network) via a wired or wireless communication link. Accordingly, the access device enables another device (e.g., a wireless station) to access the other network or some other functionality. In addition, it should be appreciated that one or both of the devices may be portable or, in some cases, relatively non-portable. Also, it should be appreciated that a wireless apparatus also may be capable of transmitting and/or receiving information in a non-wireless manner (e.g., via a wired connection) via an appropriate communication interface.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communication (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Re199, Re15, Re16, Re17) technology, as well as 3GPP2 (e.g., 1xRTT, 1xEV-DO Re10, RevA, RevB) technology and other technologies.

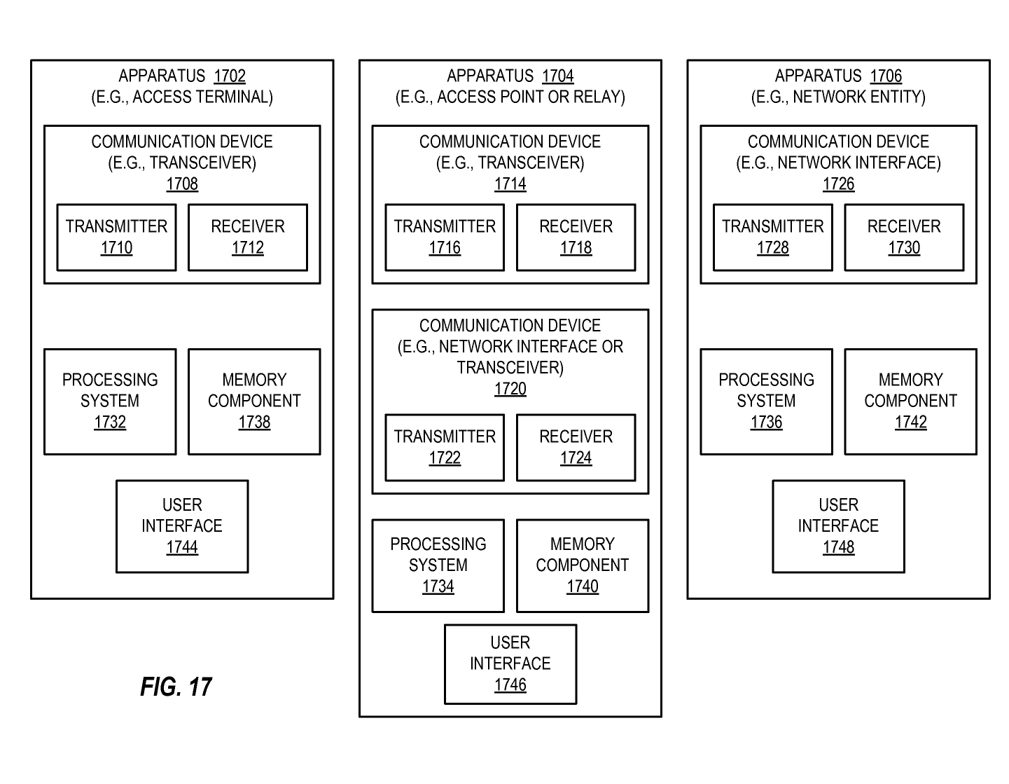

FIG. 17 illustrates several sample components (represented by corresponding blocks) that may be incorporated into an apparatus 1702, an apparatus 1704, and an apparatus 1706 (e.g., corresponding to an access terminal, an access point or relay, and a network entity (e.g., network device), respectively) to perform communication operations as taught herein. It should be appreciated that these components may be implemented in different types of apparatuses in different implementations (e.g., in an ASIC, in a system on a chip (SoC), etc.). The described components also may be incorporated into other apparatuses in a communication system. For example, other apparatuses in a system may include components similar to those described to provide similar functionality. Also, a given apparatus may contain one or more of the described components. For example, an apparatus may include multiple transceiver components that enable the apparatus to operate on multiple carriers and/or communicate via different technologies.

The apparatus 1702 and the apparatus 1704 each include at least one wireless communication device (represented by the communication devices 1708 and 1714 (and the communication device 1720 if the apparatus 1704 is a relay)) for communicating with other nodes via at least one designated radio access technology. Each communication device 1708 includes at least one transmitter (represented by the transmitter 1710) for transmitting and encoding signals (e.g., messages, indications, information, and so on) and at least one receiver (represented by the receiver 1712) for receiving and decoding signals (e.g., messages, indications, information, pilots, and so on). Similarly, each communication device 1714 includes at least one transmitter (represented by the transmitter 1716) for transmitting signals (e.g., messages, indications, information, pilots, and so on) and at least one receiver (represented by the receiver 1718) for receiving signals (e.g., messages, indications, information, and so on). If the apparatus 1704 is a relay, each communication device 1720 includes at least one transmitter (represented by the transmitter 1722) for transmitting signals (e.g., messages, indications, information, pilots, and so on) and at least one receiver (represented by the receiver 1724) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In some aspects, a wireless communication device (e.g., one of multiple wireless communication devices) of the apparatus 1704 comprises a network listen module.

The apparatus 1706 (and the apparatus 1704 if it is an access point) includes at least one communication device (represented by the communication device 1726 and, optionally, 1720) for communicating with other nodes. For example, the communication device 1726 may comprise a network interface that is configured to communicate with one or more network entities via a wire-based or wireless backhaul. In some aspects, the communication device 1726 may be implemented as a transceiver configured to support wire-based or wireless signal communication. This communication may involve, for example, sending and receiving: messages, parameters, or other types of information. Accordingly, in the example of FIG. 17, the communication device 1726 is shown as comprising a transmitter 1728 and a receiver 1730. Similarly, if the apparatus 1704 is an access point, the communication device 1720 may comprise a network interface that is configured to communicate with one or more network entities via a wire-based or wireless backhaul. As with the communication device 1726, the communication device 1720 is shown as comprising a transmitter 1722 and a receiver 1724.

The apparatuses 1702, 1704, and 1706 also include other components that may be used in conjunction with communication operations as taught herein. The apparatus 1702 includes a processing system 1732 for providing functionality relating to, for example, communicating with the apparatus 1704 as taught herein and for providing other processing functionality. The apparatus 1704 includes a processing system 1734 for providing functionality relating to, for example, defining and or using a communication channel as taught herein and for providing other processing functionality. The apparatus 1706 includes a processing system 1736 for providing functionality relating to, for example, defining a communication channel as taught herein and for providing other processing functionality. The apparatuses 1702, 1704, and 1706 include memory devices 1738, 1740, and 1742 (e.g., each including a memory device), respectively, for maintaining information (e.g., thresholds, parameters, mapping information, and so on). In addition, the apparatuses 1702, 1704, and 1706 include user interface devices 1744, 1746, and 1748, respectively, for providing indications (e.g., audible and/or visual indications) to a user and/or for receiving user input (e.g., upon user actuation of a sensing device such a keypad, a touch screen, a microphone, and so on).

For convenience, the apparatus 1702 is shown in FIG. 17 as including components that may be used in the various examples described herein. In practice, the illustrated blocks may have different functionality in different aspects. For example, functionality of the block 1734 for supporting the operations of FIG. 8 may be different as compared to functionality of the block 1734 for supporting the operations of FIG. 9.

The components of FIG. 17 may be implemented in various ways. In some implementations, the components of FIG. 17 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 1708, 1732, 1738, and 1744 may be implemented by processor and memory component(s) of the apparatus 1702 (e.g., by execution of appropriate code and/or by appropriate configuration of processor components). Similarly, some or all of the functionality represented by blocks 1714, 1720, 1734, 1740, and 1746 may be implemented by processor and memory component(s) of the apparatus 1704 (e.g., by execution of appropriate code and/or by appropriate configuration of processor components). Also, some or all of the functionality represented by blocks 1726, 1736, 1742, and 1748 may be implemented by processor and memory component(s) of the apparatus 1706 (e.g., by execution of appropriate code and/or by appropriate configuration of processor components).

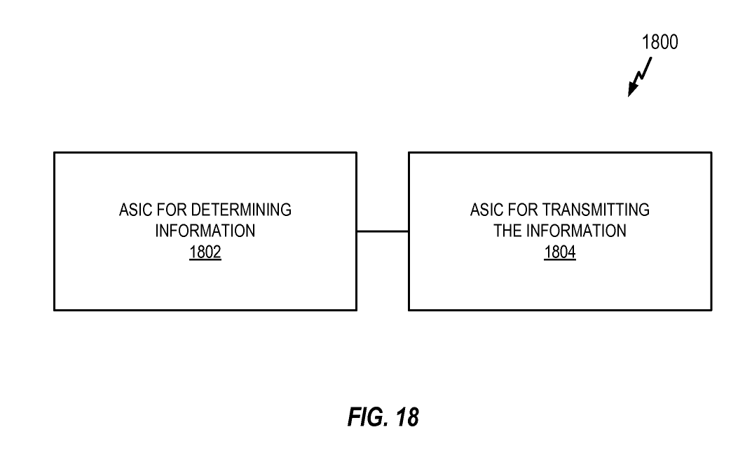

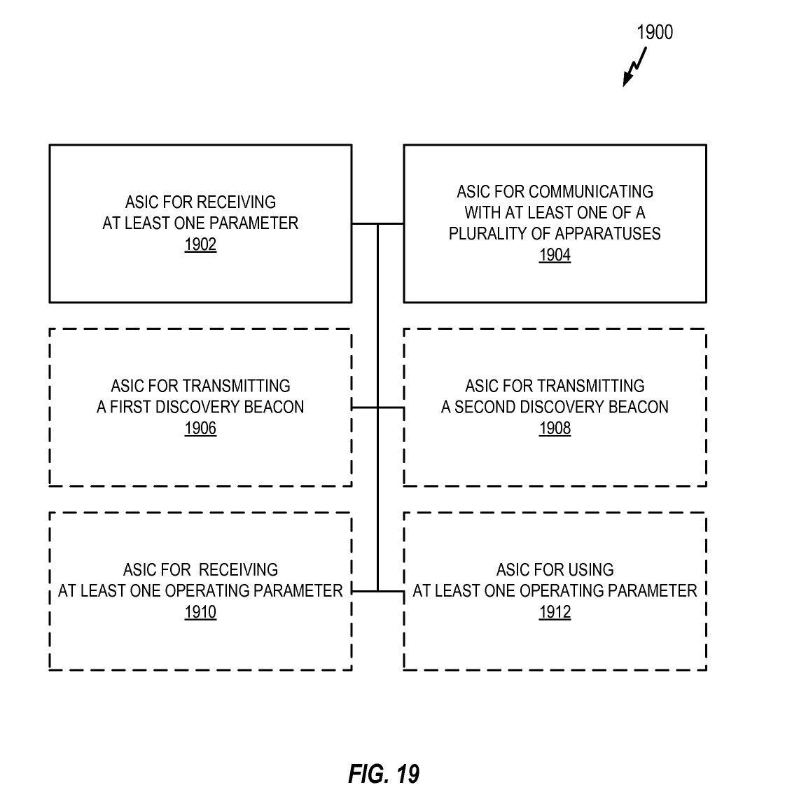

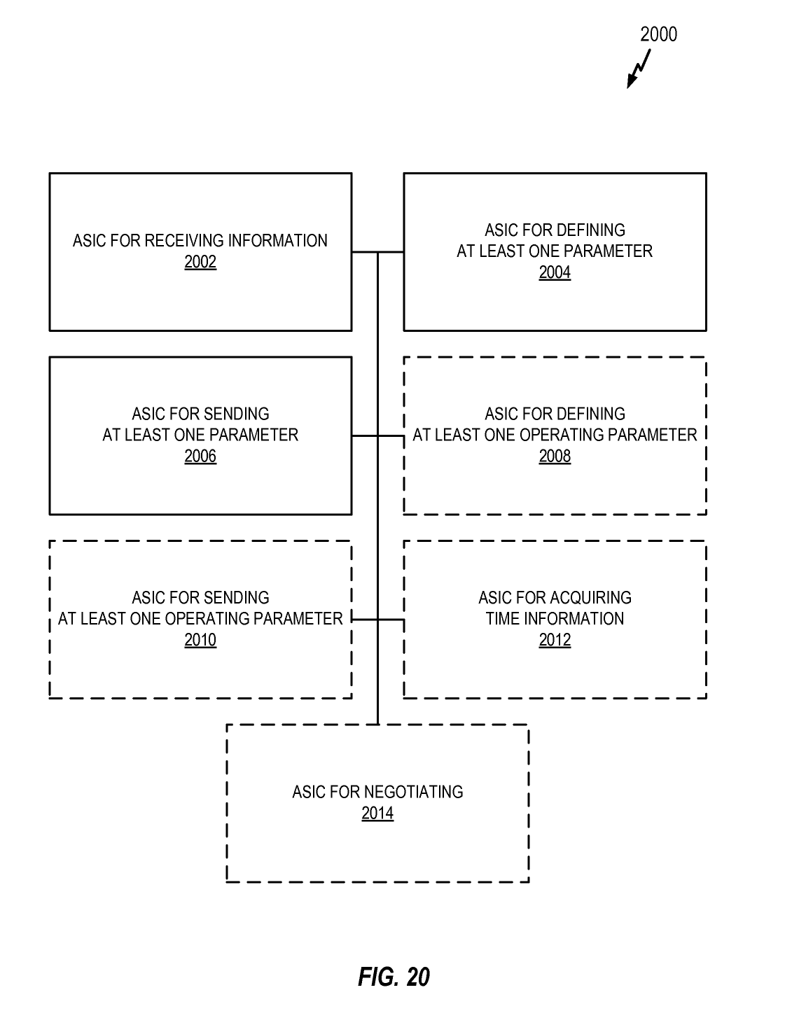

The components described herein may be implemented in a variety of ways. Referring to FIGS. 18, 19, and 20, apparatuses 1800, 1900, and 2000 are represented as a series of interrelated functional blocks that represent functions implemented by, for example, one or more integrated circuits (e.g., an ASIC) or implemented in some other manner as taught herein. As discussed herein, an integrated circuit may include a processor, software, other components, or some combination thereof.

The apparatus 1800 includes one or more modules that may perform one or more of the functions described above with regard to various figures. For example, an ASIC for determining information 1802 may correspond to, for example, a processing system as discussed herein. An ASIC for transmitting the information 1804 may correspond to, for example, a transmitter as discussed herein.

The apparatus 1900 includes one or more modules that may perform one or more of the functions described above with regard to various figures. For example, an ASIC for receiving at least one parameter 1902 may correspond to, for example, a receiver as discussed herein. An ASIC for communicating with at least one of a plurality of apparatuses 1904 may correspond to, for example, a processing system as discussed herein. An ASIC for transmitting a first discovery beacon 1906 may correspond to, for example, a transmitter as discussed herein. An ASIC for transmitting a second discovery beacon 1908 may correspond to, for example, a transmitter as discussed herein. An ASIC for receiving at least one operating parameter 1910 may correspond to, for example, a receiver as discussed herein. An ASIC for using at least one operating parameter 1912 may correspond to, for example, a processing system as discussed herein.

The apparatus 2000 includes one or more modules that may perform one or more of the functions described above with regard to various figures. For example, an ASIC for receiving information 2002 may correspond to, for example, a receiver as discussed herein. An ASIC for defining at least one parameter 2004 may correspond to, for example, a processing system as discussed herein. An ASIC for sending at least one parameter 2006 may correspond to, for example, a transmitter as discussed herein. An ASIC for defining at least one operating parameter 2008 may correspond to, for example, a processing system as discussed herein. An ASIC for sending at least one operating parameter 2010 may correspond to, for example, a transmitter as discussed herein. An ASIC for acquiring time information 2012 may correspond to, for example, a processing system as discussed herein. An ASIC for negotiating 2014 may correspond to, for example, a processing system as discussed herein.

As noted above, in some aspects these modules may be implemented via appropriate processor components. These processor components may in some aspects be implemented, at least in part, using structure as taught herein. In some aspects, a processor may be configured to implement a portion or all of the functionality of one or more of these modules. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. In some aspects one or more of any components represented by dashed boxes are optional.

As noted above, the apparatuses 1800-2000 comprise one or more integrated circuits in some implementations. For example, in some aspects a single integrated circuit implements the functionality of one or more of the illustrated components, while in other aspects more than one integrated circuit implements the functionality of one or more of the illustrated components. As one specific example, the apparatus 2000 may comprise a single device (e.g., with components 2002-2014 comprising different sections of an ASIC). As another specific example, the apparatus 2000 may comprise several devices (e.g., with the components 2002, 2006, and 2010 comprising one ASIC, and the components 2004, 2008, 2012, and 2014 comprising another ASIC).

In addition, the components and functions represented by FIGS. 18-20 as well as other components and functions described herein, may be implemented using any suitable means. Such means are implemented, at least in part, using corresponding structure as taught herein. For example, the components described above in conjunction with the “ASIC for” components of FIGS. 18-20 correspond to similarly designated “means for” functionality. Thus, one or more of such means is implemented using one or more of processor components, integrated circuits, or other suitable structure as taught herein in some implementations. Several examples follow.

In some implementations, communication device structure such as a transceiver is configured to embody the functionality of a means for receiving. For example, this structure may be programmed or designed to invoke a receive operation. In addition, this structure may be programmed or designed to process (e.g., demodulate and decode) any signals received as a result of the receive operation. In addition, this structure may be programmed or designed to output data (e.g., a data unit, channel information, an indication, or other information) extracted from the received signals as a result of the processing. Typically, the communication device structure comprises a wireless-based transceiver device or wire-based transceiver device.

In some implementations, communication device structure such as a transceiver is configured to embody the functionality of a means for sending. For example, this structure may be programmed or designed to obtain data (e.g., a data unit, channel information, an indication, or other information) to be transmitted. In addition, this structure may be programmed or designed to process (e.g., modulate and encode) the obtained data. In addition, this structure may be programmed or designed to couple the processed data to one or more antennas for transmission. Typically, the communication device structure comprises a wireless-based transceiver device or wire-based transceiver device.

In some implementations, communication device structure such as a transceiver is configured to embody the functionality of a means for transmitting. For example, this structure may be programmed or designed to obtain data (e.g., a data unit, channel information, an indication, or other information) to be transmitted. In addition, this structure may be programmed or designed to process (e.g., modulate and encode) the obtained data. In addition, this structure may be programmed or designed to couple the processed data to one or more antennas for transmission. Typically, the communication device structure comprises a wireless-based transceiver device or wire-based transceiver device.

In some implementations, processing system structure such as an ASIC or a programmable processor is configured to embody the functionality of a means for communicating. For example, this structure may be programmed or designed to obtain data (e.g., a data unit, channel information, an indication, or other information) to be communicated. In addition, this structure may be programmed or designed to process the obtained data. In addition, this structure may be programmed or designed to output the data. Complementary operations may be performed to receive data.

In some implementations, processing system structure such as an ASIC or a programmable processor is configured to embody the functionality of a means for determining information. This structure may be programmed or designed to obtain parameters from a memory device. This structure may be programmed or designed to process the parameters to provide information indicative of the parameters. The structure may be programmed or designed to then output an indication indicative of the results of the processing.

In some implementations, processing system structure such as an ASIC or a programmable processor is configured to embody the functionality of a means for defining. This structure may be programmed or designed to receive one or more input parameters. This structure may be programmed or designed to process the received input parameters to define one or more parameters. The structure may be programmed or designed to then output an indication indicative of the results of the processing.

In some implementations, processing system structure such as an ASIC or a programmable processor is configured to embody the functionality of a means for acquiring. This structure may be programmed or designed to receive information (e.g., a signal or message). This structure may be programmed or designed to process the received information to generate a timing indication. The structure may be programmed or designed to then output an indication indicative of the results of the processing (e.g., a timing indication).

In some implementations, processing system structure such as an ASIC or a programmable processor is configured to embody the functionality of a means for negotiating. This structure may be programmed or designed to establish communication with another component. This structure may be programmed or designed to generate information to be sent to the other component and process information received from the other component. The structure may be programmed or designed to then output an indication indicative of the results of the processing (e.g., a negotiated parameter).

In some implementations, processing system structure such as an ASIC or a programmable processor is configured to embody the functionality of a means for using. This structure may be programmed or designed to receive an operating parameter. This structure may be programmed or designed to process the received operating parameter to control one or more operations. The structure may be programmed or designed to then output an indication indicative of the results of the processing (e.g., the result of an operation).

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Also, it should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise a set of elements comprises one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

Those of skill in the art understand that information and signals may be represented using any of a variety of different technologies and techniques. For example, any data, instructions, commands, information, signals, bits, symbols, and chips referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by a processing system, an integrated circuit (“IC”), an access terminal, or an access point. A processing system may be implemented using one or more ICs or may be implemented within an IC (e.g., as part of a system on a chip). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising code executable (e.g., executable by at least one computer) to provide functionality relating to one or more of the aspects of the disclosure. In some aspects, a computer program product may comprise packaging materials.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A computer-readable media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer-readable medium (e.g., tangible media, computer-readable storage medium, computer-readable storage device, etc.). Such a non-transitory computer-readable medium (e.g., computer-readable storage device) may comprise any of the tangible forms of media described herein or otherwise known (e.g., a memory device, a media disk, etc.). In addition, in some aspects computer-readable medium may comprise transitory computer readable medium (e.g., comprising a signal). Combinations of the above should also be included within the scope of computer-readable media. It should be appreciated that a computer-readable medium may be implemented in any suitable computer-program product. Although particular aspects are described herein, many variations and permutations of these aspects fall within the scope of the disclosure.

Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the description.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. An apparatus for communication, comprising:
a processing system configured to determine information indicative of at least one first parameter associated with a first channel supported by the apparatus or at least one second parameter associated with a second channel supported by the apparatus; and
a transmitter configured to transmit the information via the second channel.

2. The apparatus of claim 1, wherein:
the first channel is an operating channel; and
the second channel is a discovery channel.

3. The apparatus of claim 2, wherein the discovery channel is associated with a first communication range that is longer than a second communication range associated with the operating channel.

4. The apparatus of claim 1, wherein:
the at least one first parameter indicates transmit power used by the apparatus on the first channel; and
the at least one second parameter indicates transmit power used by the apparatus on the second channel.

5. The apparatus of claim 1, wherein the information indicates at least one identifier of the apparatus.

6. The apparatus of claim 1, wherein the information indicates a primary channel of the apparatus.

7. A method of communication, comprising:
determining information indicative of at least one first parameter associated with a first channel supported by an apparatus or at least one second parameter associated with a second channel supported by the apparatus; and
transmitting the information via the second channel.

8. The method of claim 7, wherein:
the first channel is an operating channel; and
the second channel is a discovery channel.

9. The method of claim 8, wherein the discovery channel is associated with a first communication range that is longer than a second communication range associated with the operating channel.

10. The method of claim 7, wherein:
the at least one first parameter indicates transmit power used by the apparatus on the first channel; and
the at least one second parameter indicates transmit power used by the apparatus on the second channel.

11. The method of claim 7, wherein the information indicates at least one identifier of the apparatus.

12. The method of claim 7, wherein the information indicates a primary channel of the apparatus.

13. An apparatus for communication, comprising:
a receiver configured to receive at least one parameter of a discovery channel for communication among a plurality of apparatuses, wherein the discovery channel is associated with a communication range that is longer than any communication range associated with any operating channel of any of the plurality of apparatuses; and
a processing system configured to communicate with at least one of the plurality of apparatuses via the discovery channel, wherein the communication employs the received at least one parameter of the discovery channel.

14. The apparatus of claim 13, further comprising at least one transmitter configured to:
transmit a first discovery beacon via the discovery channel; and
transmit a second discovery beacon via an operating channel.

15. The apparatus of claim 14, wherein:
the first discovery beacon comprises an indication of the operating channel;
the first discovery beacon comprises an indication of transmission power used on the discovery channel; and
the second discovery beacon comprises an indication of transmission power used on the operating channel.

16. The apparatus of claim 13, wherein the at least one parameter of the discovery channel comprises at least one of: a communication window duration, a communication window periodicity, a communication window interval, a quantity of communication windows per period, a quantity of frequency hopping channels per period, a radio frequency of a frequency hopping channel, or a bandwidth of a frequency hopping channel.

17. The apparatus of claim 13, wherein:
the receiver is further configured to receive at least one operating parameter; and
the processing system is further configured to use the at least one operating parameter for the communication via the discovery channel.

18. The apparatus of claim 17, wherein the at least one operating parameter comprises at least one of: a parameter to control transmission activity during a communication window or a parameter to specify a size of a contention window.

19. The apparatus of claim 17, wherein the at least one operating parameter comprises scheduling information that specifies transmit and receive timing for each of the plurality of apparatuses during a communication window.

20. The apparatus of claim 13, wherein the communication via the discovery channel comprises communicating at least one indication of transmit power used on an operating channel.

21. The apparatus of claim 13, wherein the communication via the discovery channel comprises communicating at least one indication of: transmit power used on the discovery channel, operating channel number, primary channel number, cell-edge preferred sub-band, cell-edge preferred time slot, restricted access window schedule, location coordinates, hearable neighboring access point list, receiver sensitivity level, receiver noise floor, service set identifier, basis service set identifier, or Internet Protocol address.

22. A method of communication, comprising:
receiving at least one parameter of a discovery channel for communication among a plurality of apparatuses, wherein the discovery channel is associated with a communication range that is longer than any communication range associated with any operating channel of any of the plurality of apparatuses; and
communicating with at least one of the plurality of apparatuses via the discovery channel, wherein the communication employs the received at least one parameter of the discovery channel.

23. The method of claim 22, further comprising:
transmitting a first discovery beacon via the discovery channel; and
transmitting a second discovery beacon via an operating channel.

24. The method of claim 23, wherein:
the first discovery beacon comprises an indication of the operating channel;
the first discovery beacon comprises an indication of transmission power used on the discovery channel; and
the second discovery beacon comprises an indication of transmission power used on the operating channel.

25. The method of claim 22, wherein the at least one parameter of the discovery channel comprises at least one of: a communication window duration, a communication window periodicity, a communication window interval, a quantity of communication windows per period, a quantity of frequency hopping channels per period, a radio frequency of a frequency hopping channel, or a bandwidth of a frequency hopping channel.

26. The method of claim 22, further comprising:
receiving at least one operating parameter; and
using the at least one operating parameter for the communication via the discovery channel.

27. The method of claim 26, wherein the at least one operating parameter comprises at least one of: a parameter to control transmission activity during a communication window or a parameter to specify a size of a contention window.

28. The method of claim 26, wherein the at least one operating parameter comprises scheduling information that specifies transmit and receive timing for each of the plurality of apparatuses during a communication window.

29. The method of claim 22, wherein the communication via the discovery channel comprises communicating at least one indication of transmit power used on an operating channel.

30. The method of claim 22, wherein the communication via the discovery channel comprises communicating at least one indication of: transmit power used on the discovery channel, operating channel number, primary channel number, cell-edge preferred sub-band, cell-edge preferred time slot, restricted access window schedule, location coordinates, hearable neighboring access point list, receiver sensitivity level, receiver noise floor, service set identifier, basis service set identifier, or Internet Protocol address.
